(19) United States
(12) Patent Application Publication
(10) Pub. No.: US 2005/0124705 A1
(43) Pub. Date: Jun. 9, 2005

(54) Cosmetic or pharmaceutical, low-viscosity oil-in-water emulsions containing phospholipids

(75) Inventors: Jorg Schreiber, Hamburg (DE); Mirko Tesch, Hamburg (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Beiersdorf AG

(21) Appl. No.: 10/953,586

(22) Filed: Sep. 28, 2004

Related U.S. Application Data
(63) Continuation of application No. PCT/EP03/02983, filed on Mar. 21, 2003.

(30) Foreign Application Priority Data
Mar. 28, 2002 (DE) 102 13 955.5

(51) Int. Cl. B01F 3/08

(52) U.S. Cl. 516/53

(57) ABSTRACT

The invention is a low viscosity oil-in-water emulsion that is readily atomizable for use in cosmetic and dermatological applications and particularly for spray or aerosol applications. The oil-in-water emulsion includes at least one phospholipid and at least one oil-in water emulsifier. In some embodiments, the emulsion may also include a water-in-oil emulsifier. The invention also includes a process for preparing the emulsion.

### CROSS-REFERENCE TO RELATED APPLICATIONS

This is a continuation application of PCT/EP03/02983, filed Mar. 21, 2003, which is incorporated herein by reference in its entirety, and also claims the benefit of German Priority Application No. 102 13 955.5, filed Mar. 28, 2002.

### FIELD OF THE INVENTION

The present invention relates to low-viscosity, in particular atomizable, oil-in-water (O/W) emulsions containing phospholipids, to processes for their preparation, and to their use for cosmetic or pharmaceutical purposes. In particular, they are applied topically, can be used as wipe and fabric impregnation medium, or be atomized or foamed.

### BACKGROUND OF THE INVENTION

Cosmetic skincare is primarily understood as meaning that the natural function of the skin as a barrier against environmental influences (e.g. dirt, chemicals, microorganisms) and against the loss of substances intrinsic to the body (e.g. water, natural fats, electrolytes) is strengthened or restored.

Impairment of this function may lead to increased absorption of toxic or allergenic substances or to attack by microorganisms, leading to toxic or allergic skin reactions.

Another aim of skincare is to compensate for the loss by the skin of lipids and water caused by daily washing. This is particularly important when the natural regeneration ability is inadequate. Furthermore, skincare products should protect against environmental influences, in particular against sun and wind, and delay skin aging.

Medicinal compositions generally comprise one or more medicaments in an effective concentration. For the sake of simplicity, for a clear distinction between cosmetic and medicinal use and corresponding products, reference is made to the legal provisions of the Federal Republic of Germany (e.g. Cosmetics Directive, Foods and Drugs Act).

Cosmetic or dermatological preparations are often in the form of finely disperse multiphase systems in which one or more fat or oil phases are present besides one or more water phases. Of these systems, in turn, the actual emulsions are the most widespread.

In simple emulsions, finely disperse droplets of one phase (water droplets in water-in-oil (W/O) emulsions or lipid vesicles in oil-in-water (O/W) emulsions), surrounded by an emulsifier shell, are present in a second phase. The droplet diameters of customary emulsions are in the range from about 200 μm to about 50 μm. Such “macroemulsions” are, without further coloring additives, milky white in color and opaque.

The use of customary cosmetic emulsifiers is in itself safe. Nevertheless, emulsifiers, like ultimately any chemical substance, may in individual cases cause allergic reactions or reactions based on user hypersensitivity.

For example, it is known that certain photodermatoses are triggered by certain emulsifiers, but also by various fats, and simultaneous exposure to sunlight. Such photodermatoses are also called “Mallorca acne”. One object of the present invention was therefore to develop sunscreen products.

### SUMMARY OF THE INVENTION

Thus, the present invention relates, as particular embodiments, to cosmetic and dermatological photoprotective preparations, in particular skincare cosmetic and dermatological photoprotective preparations.

The harmful effect of the ultraviolet part of solar radiation on the skin is generally known. While rays with a wavelength of less than 290 nm (the so-called UVC region) are absorbed by the ozone layer in the earth's atmosphere, rays in the range between 290 nm and 320 nm, the so-called UVB region, cause erythema, simple sunburn or even burns of greater or lesser severity. The erythema activity maximum of sunlight is given as the relatively narrow range around 308 nm.

Numerous compounds are known for protecting against UVB radiation; these are mostly derivatives of 3-benzylidenecamphor, of 4-aminobenzoic acid, of cinnamic acid, of salicylic acid, of benzophenone and also of 2-phenylbenzimidazole.

For the range between 320 nm and about 400 nm, the so-called UVA region, it is also important to have available filter substances since rays of that region can also cause damage. For example, it has been proven that UVA radiation leads to damage of the elastic and collagenous fibers of connective tissue, causing premature aging of the skin, and that it is to be regarded as a cause of numerous phototoxic and photoallergic reactions. The harmful effect of UVB radiation can be intensified by UVA radiation. UV radiation can, however, also lead to photochemical reactions, in which case the photochemical reaction products then intervene in the skin's metabolism.

In order to prevent these reactions, antioxidants and free-radical scavengers can additionally be incorporated into the cosmetic and/or dermatological formulations.

Most of the inorganic pigments which are known for use in cosmetics for protecting the skin against UV rays are UV absorbers or UV reflectors. These pigments are oxides of titanium, zinc, iron, zirconium, silicon, manganese, aluminum, cerium and mixtures thereof, and also modifications.

Owing to their good atomizability, phospholipid-containing, low-viscosity O/w emulsions are also suitable for other cosmetic dermatological applications, for example deodorants, meaning that the present invention relates, in a particular embodiment, to phospholipid-containing, low-viscosity O/W emulsions as a basis for cosmetic deodorants.

Cosmetic deodorants serve to eliminate body odor which arises when fresh perspiration, which is in itself odorless, is decomposed by microorganisms. Customary cosmetic deodorants are based on different active principles. In so-called antiperspirants, the formation of perspiration can be reduced by astringents—chiefly, aluminum salts such as aluminum hydroxychloride (aluminum chlorohydrate). By using antimicrobial substances in cosmetic deodorants it is possible to reduce the bacterial flora on the skin. In an ideal case, only the odor-causing microorganisms would be effectively reduced. The flow of perspiration itself is not influenced by this, and in an ideal case only microbial decomposition of the perspiration is temporarily stopped. The combination of astringents with antimicrobial substances in one and the same composition is also customary.

Deodorants should satisfy the following conditions:

1) They should effect reliable deodorization.
2) The natural biological processes of the skin must not be impaired by the deodorants.
3) The deodorants must be harmless in the event of an overdose or other use which is not in accordance with the directions.
4) They should not become concentrated on the skin following repeated application.
5) They should be easy to incorporate into customary cosmetic formulations.

Liquid deodorants, for example, aerosol sprays, roll-ons, and the like, and also solid preparations, for example, deodorant sticks, powders, powder sprays, intimate cleansing compositions, etc. are known and customary.

The use of lecithin-containing, low-viscosity O/W emulsions as bases for deodorizing or antiperspirant preparations are also known. Their relatively high content of emulsifiers, together with the described disadvantages, has hitherto been a shortcoming which is in need of remedying.

A further object of the present invention was therefore to develop preparations which are suitable as bases for cosmetic deodorants or antiperspirants and do not have the disadvantages of the prior art.

It was also an object of the invention to develop cosmetic bases for cosmetic deodorants which are characterized by good skin compatibility.

In addition, it was an object of the present invention to make available products based on lecithin-containing, low-viscosity O/W emulsions having the broadest possible application diversity. For example, bases for preparation forms such as cleansing emulsions, face care and body care preparations were to be provided, but also decidedly medicinal-pharmaceutical administration forms, for example, preparations against acne and other skin phenomena.

In a particular embodiment, the invention therefore relates to cleansing emulsions, in particular face cleansing emulsions, preferably make-up removers, for example, eye make-up removers.

Such preparations are known per se. These are usually mixtures of cosmetic oils or aqueous preparations of surface-active substances whose function is to solubilize the impurity or the make-up entities and to remove them from the skin.

Water-resistant eye make-up, for example mascara, can only be removed satisfactorily with aqueous-based make-up removers containing specific surfactants. However, these surfactants often only have limited physiological compatibility. When such substances come into contact with the mucous membrane, in particular the mucous membrane of the eye, they lead to irritations which manifest themselves, for example, in a reddening of the eyes. Reactions of this type are typical of surfactant-containing products. An object of the present invention was therefore to remedy such problems.

In a further embodiment, the present invention relates to hair cosmetic preparations. In particular, the present invention relates to hair cosmetic preparations for the care of hair and the scalp. In a preferred embodiment, the present invention relates to preparations which serve to strengthen individual hairs and impart hold and body to the hairstyle overall.

Roughly speaking, human hair can be divided into the living part, the hair root, and the dead part, the hair shaft. The hair shaft in turn comprises the medulla which, however, as result of evolution, has become insignificant for modern man and has receded, and in cases of thin hair is often entirely absent, and also the cortex surrounding the medulla and the cuticula which encloses the totality of medulla and cortex.

The cuticula in particular, but also the keratinous region between the cuticula and cortex, as the outer sheath of the hair, are exposed to particular demands as a result of environmental influences, as a result of combing and brushing, but also as a result of hair treatment, in particular hair coloring and hair shaping, e.g., permanent waving processes.

If the stress is particularly aggressive, for example, bleaching with oxidizing agents such as hydrogen peroxide, in which the pigments distributed within the cortex are destroyed by oxidation, the inside of the hair can also be affected. If human hair is to be colored permanently, in practice only oxidizing hair coloring processes are suitable. During the oxidative coloring of hair, the dye chromophores are formed as a result of the reaction of precursors (phenols, aminophenols, and less frequently also diamines) and bases (in most cases p-phenylenediamine) with the oxidizing agent, in most cases hydrogen peroxide. Hydrogen peroxide concentrations of about 6% are usually used for this.

It is usually assumed that besides the coloring action, a bleaching action also takes place as a result of the hydrogen peroxide. In oxidatively colored human hair, as in the case of bleached hair, microscopic holes are detectable at the points where melanin granules were present. The fact is that the oxidizing agent hydrogen peroxide can react not only with the dye precursors, but also with the hair substance and as a result can cause damage to the hair under certain circumstances.

Washing the hair with aggressive surfactants can also stress the hair, and at least reduce its appearance or the appearance of the hairstyle overall. For example, certain water-soluble constituents of the hair (e.g., urea, uric acid, xanthine, keratin, glycogen, citric acid, and lactic acid) can be leached out as result of hair washing.

For these reasons, some hair care cosmetics which are intended to be rinsed out of the hair again once they have acted, and some of those which are to remain on the hair have been used for a relatively long time. The latter can be formulated such that they not only serve to care for the individual hairs, but also improve the appearance of the hairstyle overall, for example by imparting more body to the hair, fixing the hairstyle over a longer period or improving its ease of styling.

By using quaternary ammonium compounds, for example, the combability of the hair can be decisively improved. Such compounds attach to the hair and are often still detectable on the hair after the hair has been washed a number of times.

However, the prior art has lacked active ingredients and preparations which satisfactorily care for damaged hair. Preparations which were intended to give body to the hairstyle have also often proven to be inadequate, or they were at least unsuitable for use as hair care preparations. The hairstyle-fixing preparations of the prior art generally comprise, for example, viscous constituents, which run the risk of giving rise to a feeling of stickiness, which often has to be compensated for by skillful formulation. An object was therefore also to overcome these disadvantages of the prior art.

Finally, the route to emulsions which can be used internally, for example for the parenteral administration of pharmaceutical active ingredients and also for parenteral feeding, should also in principle be opened up by the present invention.

It was a particular object of the present invention to provide finely disperse preparations of the oil-in-water type with the lowest possible emulsifier content which do not have the disadvantages of the prior art and which can be used for a very wide variety of cosmetic and dermatological applications, for example the above-described uses. It was a further object of the invention to enrich the limited supply of finely disperse preparations of the oil-in-water type of the prior art.

A particular object of the present invention was to make available low-viscosity preparations based on finely disperse systems of the oil-in-water type with the lowest possible emulsifier content which do not have the disadvantages of the prior art and which can be used for a very wide variety of cosmetic and/or dermatological applications, for example the uses described above. A further object of the invention was to enrich the limited range of low-viscosity preparations based on finely disperse, phospholipid-containing systems of the oil-in-water type of the prior art.

It was a further object of the invention to enrich the limited supply of low-viscosity preparations based on finely disperse phospholipid-containing systems of the oil-in-water type of the prior art which are atomizable or can be used on or as impregnation medium for wipes, fabric, or can be applied from a pump foamer as foam.

Lecithin-containing emulsions for cosmetic, pharmaceutical, parenteral applications are known from the literature. These are often obtained by high-pressure homogenization. It is a disadvantage that high shear forces arise here on the droplets and metal dust forms which can only be removed with difficulty from the corresponding presentation forms. In addition, ultrasound can also be used to prepare corresponding emulsions. A disadvantage is that these processes are expensive due to the high input of energy.

High-pressure homogenization or ultrasound for the preparation of parenteral emulsions, for cosmetic or pharmaceutical applications are described in the following literature references. Int. J. Pharm. 163, 1998, 81; J. Pharm. Belg. 52, 1997, 110; J. Pharm. Sci. 82, 1993, 1069; J. Pharm. Sci. 83, 1994, 72; Parf. und Kosmet. 10, 1994, 652; 3, 1995, 152; Pharm. Res. 12, 1995, 1273; SÖFW 9, 1994, 530.

Low-viscosity microemulsions for oral applications based on lecithin/ethanol/propylene glycol are described in WO 92/02207. In addition, the thickening to give the microemulsion gel containing gelatin as water-soluble polymer is described therein. A disadvantage for cosmetic applications is the lack of a cosmetic oil phase. Lecithin-containing transparent oil-in-water emulsions thickened with gelatin are also described in FR 2618351. The transparency is achieved by adjusting the refractive indices of water and oil phase. Accordingly, no microemulsion is present here.

EP 406162 B1 describes a process for the preparation of a nanoemulsion with triglycerides or fatty acid esters. On page 2, lines 36 to 43 and on page 3, lines 18 to 28 it is emphasized that the emulsifier lecithin should have a lamellar liquid-crystalline structure which is then processed using a high-pressure homogenizer to give the nanoemulsion.

DE 3930928 C2 describes cyclosporin-containing pharmaceutical formulations based on a microemulsion. Besides cyclosporin as active ingredient, the microemulsion concentrate used is advantageously propylene glycol or glycofurol as hydrophilic component. On page 6, lines 7 to 12, it is stated that these concentrates are O/W or W/O macroemulsions. The gel state which is advantageously passed through, which is not to be regarded as a macroemulsion, and the final formation of low-viscosity, lecithin-containing emulsions is not mentioned. In addition, short-chain ethers such as transcutol and glycofurol are less suitable for cosmetic purposes due to penetration.

DE 3302898 describes lecithin-containing systems comprising fatty acids and protein condensates from a fatty acid, ethoxylated sterols. The choice of ingredients, the process for the preparation can only be used to a limited degree. DE 4410710 describes emulsions containing lecithin and a hydrophobic coemulsifier (W/O emulsifier). Low-viscosity (atomizable) emulsions comprising O/W emulsifiers, W/O emulsifiers and phospholipids were not described as being advantageous. DE 3129340 describes emulsions comprising lecithin and saponoside as emulsifier which are also stabilized by aloe juice. A generally applicable process without these substances is not described. WO 0037042 describes a process for the preparation of low-viscosity transparent lecithin-containing microemulsions. A process for the preparation of atomizable emulsions is not described.

Lecithin organogels are described in the following literature references. Colloid Polymer Science 268, 1990, 356; Colloid J. 58, 1996, 117; Colloid Polym. Sci. 268, 1990, 356; Int. J. Pharm. 137, 1996, 117; J. Phys. Chem. 92, 1988, 829; J. Pharm. Sci. 81, 1992, 871; J. Contr. Rel. 34, 1995, 53; Proced. Intern. Symp. Control. Rel. Bioact. Mater. 17, 1990, 421; Progr. Colloid Polym. Sci. 105, 1997, 204; Progr. Colloid Polym. Sci. 106, 1997, 228; Skin. Pharmacol. 9, 1996, 124. These organogels are obtained by adding small amounts of water to a mixture of organic solvent and lecithin. Here, when water is added, the inverse micelles form cylinder-like water-filled micelles (“wormlike micelles”), which become entangled with one another and thus explain the high viscosity of these mixtures. (Colloid Polym. Sci. 268, 1990, 356).

Strictly speaking, these lecithin gels do not represent microemulsion gels since the dispersed phase is not in droplet form and also a corresponding viscosity-increasing substance for the continuous phase is missing. Neither is it described that these gels of the prior art can also be obtained in the presence of an O/W emulsifier. Neither is it described that these gels can be converted in the presence of water into other colloidochemical phases, such as, for example, O/W macroemulsions. Neither is it described that, in the presence of a O/W emulsifier, gel-like preparations can be obtained which can be converted in a targeted manner into low-viscosity, phospholipid-containing O/W emulsions by dilution with water. Neither is it described that, in the presence of an O/W emulsifier or a W/O emulsifier, gel-like preparations can be obtained which can be converted in a targeted manner into low-viscosity, phospholipid-containing O/W emulsions by dilution with water. It was an object of the invention to avoid said disadvantages. These objects are achieved according to the invention.

The invention provides a process for preparing low-viscosity, in particular atomizable, phospholipid-containing emulsions of the oil-in-water type, comprising a water phase and an oil phase, which are composed essentially of difficultly volatile constituents, comprising at least one phospholipid and at least one oil-in-water emulsifier and optionally at least one W/O emulsifier. In one embodiment, the low viscosity emulsion may be obtainable by adding part of the water phase with its constituents to the oil phase with its constituents, in particular the phospholipid and the O/W emulsifier and optionally the W/O emulsifier, where the phases are mixed together and a gel state is obtained which is converted into a low-viscosity O/W emulsion through further addition of the water phase, where the phases can, if desired, comprise further auxiliaries, additives and/or active ingredients.

Advantageously, the water phase is metered into or added dropwise to the oil phase until there is an increase in the viscosity, or a gel forms, and then the remaining water phase is metered in. The phospholipid is advantageously dissolved in the oil phase (if necessary at elevated temperature). It is, however, also possible to dissolve the phospholipid in the oil at room temperature. The O/W emulsifier and optionally the W/O emulsifier can be added directly to the oil phase, only at the stage of gel formation, or following preparation of the “pure” phospholipid organogel. The water phase can be added at room temperature or at elevated temperature. The droplet diameters of the preparations according to the invention are preferably in the ranges specified at the beginning.

### DETAILED DESCRIPTION OF THE INVENTION

In accordance with the invention, “lecithins” also means the phospholipids, which include, for example, the following substances: phosphatidic acids, the actual lecithins, cardiolipins, lysophospholipids, lysolecithins, plasmalogens, phosphosphingolipids, and sphingomyelins. Preferred substances are described below.

Phosphatidic acids are glycerol derivatives which have been esterified in the 1-sn- and 2-position with fatty acids (1-sn-position: mostly saturated, 2-position: mostly mono- or polyunsaturated), but on atom 3-sn with phosphoric acid, and are characterized by the general structural formula:

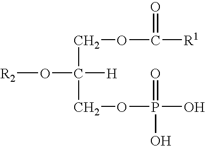

In the phosphatidic acids which occur in human or animal tissue, the phosphate radical is in most cases esterified with aminoalcohols such as choline (lecithin=3-sn-phosphatidylcholine) or 2-aminoethanol (ethanolamine) or L-serine (cephalin=3-sn-phosphatidylethanolamine or sn-phosphatidyl-L-serine), with myoinositol to give the phosphoinositides [1-(3-sn-phosphatidyl)-D-myoinositols], common in tissues, with glycerol to give phosphatidyl glycerols. Particular preference is given to lecithins (=3-sn-phosphatidylcholine). Lecithins are characterized by the general structural formula: 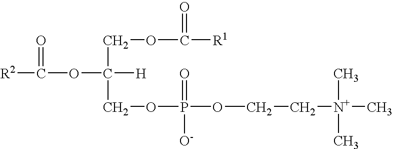
where R¹ and R² are typically unbranched aliphatic radicals having 15 or 17 carbon atoms and up to 4 cis double bonds.

Cardiolipins (1,3-bisphosphatidyl glycerols) are phospholipids of two phosphatidic acids linked via glycerol. Lysophospholipids are obtained when an acyl radical is cleaved off by phospholipase A from phospholipids (e.g., lysolecithins). Lysophospholipids are characterized by the general structural formula:

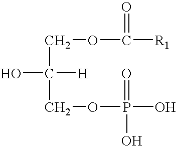

Lysolecithins, for example, are characterized by the general structural formula: 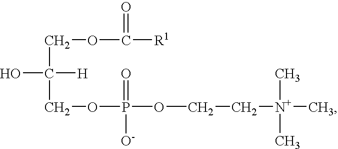
where R and R² are typically unbranched aliphatic radicals having 15 or 17 carbon atoms and up to 4 cis double bonds.

The phospholipids also include plasmalogens, in which an aldehyde (in the form of an enol ether) is bonded in the 1-position instead of a fatty acid; the O-1-sn-alkenyl compounds corresponding to the phosphatidylcholines are called, for example, hot phosphatidalcholines.

Phosphosphingolipids are based on the basic structure of sphingosine or else phytosphingosine, which are characterized by the following structural formula: 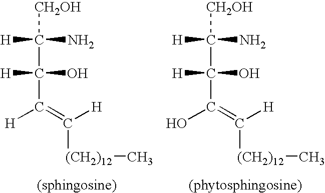
Modifications of sphingolipids are characterized, for example, by the general basic structural formula: 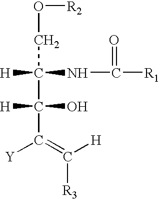
in which R₁ and R₃, independently of one another, are saturated or unsaturated, branched or unbranched alkyl radicals having 1 to 28 carbon atoms, R₂ is chosen from the group: hydrogen atom, saturated or unsaturated, branched or unbranched alkyl radicals having 1 to 28 carbon atoms, sugar radicals, phosphate groups which are unesterified or esterified with organic radicals, sulfate groups which are unesterified or esterified with organic radicals, and Y is either a hydrogen atom, a hydroxyl group or another heterofunctional radical.
Sphingophospholipids: 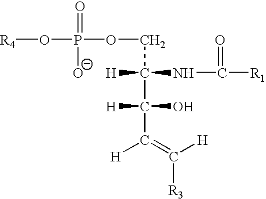
where R₁ and R₃ are alkyl radicals, R₄ is an organyl radical.
Sphingomyelins are organophosphorylated sphingolipids of the type

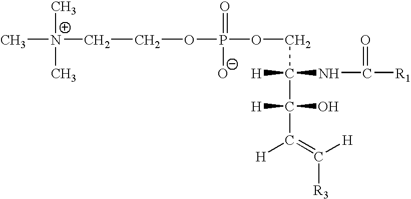

Particularly preferred phospholipids are lecithins. Types of lecithin which are to be used advantageously are chosen from crude lecithins which have been deoiled, fractionated, spray-dried, acetylated, hydrolyzed, or hydrogenated. They are available commercially. Preference is given to soya lecithins.

Phospholipids to be used advantageously according to the invention are, for example, available commercially under the trade names Phospholipon 25 or Phospholipon 90 (Nattermann), Emulmetik 120 (Lucas Meyer), Sternpur E (Stern), Sternpur PM (Stern), Nathin 3KE (Stern), Phospholipon 90H (Nattermann/Rhône-Poulenc), and Lipoid S 100 (Lipoid).

In the presence of the O/W emulsifier and optionally the W/O emulsifier, new types of gels may form in which are also present other colloidochemical phases than the “pure” lecithin organogels known in the literature, such as, for example, lamellar liquid crystals, cubic phases, bicontinuous microemulsion gels, O/W microemulsion gels, inversely hexagonal phases, hexagonal phases, and inversely micellar phases. All of these preparations which are distinguished by a viscosity increase and are, for example, cream-like, are referred to here as “gels”. The further addition of the water phase to the gel decreases the viscosity and a low-viscosity O/W emulsion is formed.

The intermediate gel formation according to the invention (i.e., the corresponding colloidochem. phase) and its targeted degradation through dilution with water (i.e., conversion of the colloidochem. phase into another phase) makes it possible to prepare finely divided O/W emulsions. In this way, it is possible for the first time to use a large number of O/W emulsifiers and W/O emulsifiers. In addition, the higher variability when selecting O/W emulsifiers and W/O emulsifiers favors a greater variety of cosmetic oil phases. In addition, as a result of the intermediate gel formation, hydrophilic, lipophilic and interface-active domains are formed within the gel so that active ingredients of varying polarity can be solubilized in parallel very much more easily since the active ingredients dissolve in the corresponding domains of their own free will corresponding to their hydrophilicity/lipophilicity.

For the modified organogels, the following quantitative percentages by weight, in each case based on the total weight of the preparations, are preferred:

| | |
|---|---|
| Phospholipid: | 0.1-50% |
| O/W emulsifier: | 0.1-70% |
| W/O emulsifier: | 0.1-70% |
| Oil phase: | 5-90% |
| Additives for the oil phase: | 0.01-15% |
| Additives for the water phase: | 0.01-35% |
| Water | ad 100% |

The weight ratio of phospholipid/(O/W emulsifier/W/O emulsifier) in the preparations according to the invention can vary, e.g., from 1:30 to 2:1. Preferably, the ratio of phospholipid/OW emulsifier is 1:15 to 1:1. Particularly preferably, the ratio of phospholipid/OW emulsifier is 1:6 to 1:1.3. Here, the ratio of (phospholipid+W/O emulsifier) to O/W emulsifier can vary, e.g., 1:30 to 2:1. Preferably, the ratio of (phospholipid+W/O emulsifier) to O/W emulsifier is 1:6 to 1:1.3.

Particularly advantageous for the purposes of the present invention are emulsions of the oil-in-water type which comprise a discontinuous oil phase and a continuous water phase; optionally comprising at least one W/O emulsifier; comprising at least one phospholipid; and comprising at least one O/W emulsifier, where the O/W emulsifier(s) are chosen advantageously from the group of:fatty alcohol ethoxylates of the general formula: R—O—(—CH₂—CH₂—O—)ₙ—H, where R is a branched or unbranched alkyl, aryl, or alkenyl radical and n is a number from 10 to 50; ethoxylated wool wax alcohols; polyethylene glycol ethers of the general formula: R—O—(—CH₂—CH₂—O—)ₙ—R′, where R and R′, independently of one another, are branched or unbranched alkyl or alkenyl radicals and n is a number from 10 to 80; fatty acid ethoxylates of the general formula: R—COO—(—CH₂—CH₂—O—)ₙ—H, where R is a branched or unbranched alkyl or alkenyl radical and n is a number from 10 to 40; etherified fatty acid ethoxylates of the general formula: R—COO—(—CH₂—CH₂—O—)ₙ—R′, where R and R′, independently of one another, are branched or unbranched alkyl or alkenyl radicals and n is a number from 10 to 80; esterified fatty acid ethoxylates of the general formula: R—COO—(—CH₂—CH₂—O—)ₙ—C(O)—R′, where R and R′, independently of one another, are branched or unbranched alkyl or alkenyl radicals and n is a number from 10 to 80: polyethylene glycol glycerol fatty acid esters of saturated or unsaturated, branched or unbranched fatty acids and having a degree of ethoxylation between 3 and 50; ethoxylated sorbitan esters and having a degree of ethoxylation of from 3 to 100; cholesterol ethoxylates and having a degree of ethoxylation between 3 and 50; ethoxylated triglycerides and having a degree of ethoxylation between 3 and 150; alkyl ether carboxylic acids of the general formula: R—O—(—CH₂—CH₂—O—)ₙ—CH₂—COOH or cosmetically or pharmaceutically acceptable salts thereof, where R is a branched or unbranched alkyl or alkenyl radical having 5 to 30 carbon atoms and n is a number from 5 to 30, polyoxyethylene sorbitol fatty acid esters based on branched or unbranched alkanoic or alkenoic acids and having a degree of ethoxylation of from 5 to 100, for example of the sorbeth type; alkyl ether sulfates or the acids on which these sulfates are based of the general formula: R—O—(—CH₂—CH₂—O—)ₙ—SO₃—H with cosmetically or pharmaceutically acceptable cations, where R is a branched or unbranched alkyl or alkenyl radical having 5 to 30 carbon atoms and n is a number from 1 to 50; fatty alcohol propoxylates of the general formula: R—O—(—CH₂—CH(CH₃)—O—)ₙ—H, where R is a branched or unbranched alkyl or alkenyl radical and n is a number from 10 to 80; polypropylene glycol ethers of the general formula: R—O—(—CH₂—CH(CH₃)—O—)ₙ—R′, where R and R′, independently of one another, are branched or unbranched alkyl or alkenyl radicals and n is a number from 10 to 80; propoxylated wool wax alcohols; etherified fatty acid propoxylates of the general formula: R—COO—(—CH₂—CH(CH₃)—O—)ₙ—R′, where R and R′, independently of one another, are branched or unbranched alkyl or alkenyl radicals and n is a number from 10 to 80; esterified fatty acid propoxylates of the general formula: R—COO—(—CH₂—CH(CH₃)—O—)ₙ—C(O)R′, where R and R′, independently of one another, are branched or unbranched alkyl or alkenyl radicals and n is a number from 10 to 80; fatty acid propoxylates of the general formula: R—COO—(—CH₂—CH(CH₃)—O—)ₙ—H, where R is a branched or unbranched alkyl or alkenyl radical and n is a number from 10 to 80; polypropylene glycol glycerol fatty acid esters of saturated or unsaturated, branched or unbranched fatty acids and having a degree of propoxylation between 3 and 80; propoxylated sorbitan esters having a degree of propoxylation from 3 to 100; cholesterol propoxylates having a degree of propoxylation from 3 to 100; propoxylated triglycerides having a degree of propoxylation from 3 to 100; alkyl ether carboxylic acids of the general formula: R—O—(—CH₂—CH(CH₃)—O—)ₙ—CH₂—COOH, or cosmetically or pharmaceutically acceptable salts thereof, where R is a branched or unbranched alkyl or alkenyl radical and n is a number from 3 to 50; alkyl ether sulfates or the acids on which these sulfates are based of the general formula: R—O—(—CH₂—CH(CH₃)—O—)ₙ—SO₃—H with cosmetically or pharmaceutically acceptable cations, where R is a branched or unbranched alkyl or alkenyl radical having 5 to 30 carbon atoms and n is a number from 1 to 50; fatty alcohol ethoxylates/propoxylates of the general formula: R—O—Xₙ—Yₘ—H, where R is a branched or unbranched alkyl or alkenyl radical, and X and Y are not identical and are in each case either an oxyethylene group or an oxypropylene group and n and m, independently of one another, are numbers from 5 to 50; polypropylene glycol ethers of the general formula R—O—Xₙ—Yₘ—R′, where R and R′, independently of one another, are branched or unbranched alkyl or alkenyl radicals, and X and Y are not identical and are in each case either an oxyethylene group or an oxypropylene group and n and m, independently of one another, are numbers from 5 to 100; etherified fatty acid propoxylates of the general formula: R—COO—Xₙ—Yₘ—R′, where R and R′, independently of one another, are branched or unbranched alkyl or alkenyl radicals, and X and Y are not identical and in each case are either an oxyethylene group or an oxypropylene group and n and m, independently of one another, are numbers from 5 to 100; fatty acid ethoxylates/propoxylates of the general formula: R—COO—Xₙ—Yₘ—H, where R is a branched or unbranched alkyl or alkenyl radical, and X and Y are not identical and are in each case either an oxyethylene group or an oxypropylene group and n and m, independently of one another, are numbers from 5 to 50; polyglycerol methylglucose esters of saturated or unsaturated, branched or unbranched alkane carboxylic acids or hydroxycarboxylic acids with a chain length of 8 to 24, in particular 12 to 18, carbon atoms; glycerol fatty acid citrates; water-dispersible silicone emulsifiers; and polygylcerol esters.

If desired, the O/W emulsion may also comprise one or more W/O emulsifiers, where this W/O emulsifier is chosen from the group of fatty alcohol ethoxylates of the general formula: R—O—(—CH₂—CH₂—O—)ₙ—H, where R is a branched or unbranched alkyl, aryl or alkenyl radical and n is a number from 1 to 10; polyethylene glycol ethers of the general formula: R—O—(—CH₂—CH₂—O—)ₙ—R′, where R and R′, independently of one another, are branched or unbranched alkyl or alkenyl radicals and n is a number from 1 to 30; fatty acid ethoxylates of the general formula: R—COO—(—CH₂—CH₂—O—)ₙ—H, where R is a branched or unbranched alkyl or alkenyl radical and n is a number from 1 to 20; esterified fatty acid ethoxylates of the general formula: R—COO—(—CH₂—CH₂—O—)ₙ—C(O)—R′, where R and R′, independently of one another, are branched or unbranched alkyl or alkenyl radicals and n is a number from 1 to 20; esterified fatty acid ethoxylates of the general formula: R—COO—(—CH₂—CH₂—O—)ₙ—C(O)—R′, where R and R′, independently of one another, are branched or unbranched alkyl, hydroxyalkyl or alkenyl radicals and n is a number from 1 to 40; etherified fatty acid ethoxylates of the general formula: R—COO—(—CH₂—CH₂—O—)ₙ—R′, where R and R′, independently of one another, are branched or unbranched alkyl or alkenyl radicals and n is a number from 1 to 40; fatty alcohol propoxylates of the general formula: R—O—(—CH₂—CH(CH₃)—O—)ₙ—H, where R is a branched or unbranched alkyl or alkenyl radical and n is a number from 1 to 30; polyoxyethylene sorbitan fatty acid esters based on branched or unbranched alkanoic or alkenoic acids and having a degree of ethoxylation of from 1 to 10; cholesterol ethoxylates having a degree of ethoxylation between 1 and 10; ethoxylated glycerides having a degree of ethoxylation of from 1 to 30; ethoxylated triglycerides having a degree of ethoxylation between 1 and 30; monoglycerol ethers of the type R—O—CH₂—C(H)OH—CH₂OH, where R is a branched or unbranched alkyl, aryl or alkenyl radical and monoglycerol esters of the type RC(O)OCH₂—C(H)OH—CH₂OH, where R is a branched or unbranched alkyl, hydroxyalkyl, aryl, or alkenyl radical; diglycerol esters of the type RC(O)OCH₂—C(H)OH—CH₂OC(O)R′, where R and R′, independently of one another, are branched or unbranched alkyl, hydroxyalkyl, or alkenyl radicals and n is a number from 1 to 30; polyglycerolmono- or di- or polyesters, where the fatty acids, independently of one another, are branched or unbranched alkyl, hydroxyalkyl, or alkenyl radicals; pentaerythritol esters, where the fatty acids, independently of one another, are branched or unbranched alkyl, hydroxyalkyl, or alkenyl radicals; propylene glycol esters, where the fatty acids, independently of one another, are branched or unbranched alkyl, hydroxyalkyl, or alkenyl radicals; sorbitan esters, where the fatty acids, independently of one another, are branched or unbranched alkyl, hydroxyalkyl, or alkenyl radicals; fatty alcohols R—OH and fatty acids RCOOH, where R is a branched or unbranched alkyl or alkenyl radical; silicone emulsifiers, such as, for example, dimethicone copolyol, alkyl dimethicone copolyol (cetyl dimethicone copolyol), alkyl methicone copolyols (lauryl methicone copolyol), or octyl dimethicone ethoxy glucoside; methylglucose esters, where the fatty acids, independently of one another, are branched or unbranched alkyl, hydroxyalkyl or alkenyl radicals.

The total emulsifier content is preferably 0.01 to 20% by weight, based on the total weight of the preparation.

In particular, it is advantageous if the O/W emulsifier or the O/W emulsifiers is or are chosen from the group of: fatty alcohol ethoxylates of the general formula R—O—(—CH₂—CH₂—O—)ₙ—H, where R is a branched or unbranched alkyl or alkenyl radical having 5 to 30 carbon atoms and n is a number from 10 to 25; ethoxylated wool wax alcohols with HLB values of 11 to 16; polyethylene glycol ethers of the general formula: R—O—(—CH₂—CH₂—O—)ₙ—R′, where R and R′, independently of one another, are branched or unbranched alkyl or alkenyl radicals having 5 to 30 carbon atoms and n is a number from 10 to 25; fatty acid ethoxylates of the general formula: R—COO—(—CH₂—CH₂—O—)ₙ—H, where R is a branched or unbranched alkyl or alkenyl radical having 5 to 30 carbon atoms and n is a number from 10 to 25; etherified fatty acid ethoxylates of the general formula: R—COO—(—CH₂—CH₂—O—)ₙ—R′, where R and R′, independently of one another, are branched or unbranched alkyl or alkenyl radicals having 5-30 carbon atoms and n is a number from 10 to 50; esterified fatty acid ethoxylates of the general formula: R—COO—(—CH₂—CH₂—O—)ₙ—C(O)—R′, where R and R′, independently of one another, are branched or unbranched alkyl or alkenyl radicals having 5 to 30 carbon atoms and n is a number from 10 to 50; polyethylene glycol glycerol fatty acid esters of saturated or unsaturated, branched or unbranched fatty acids having 6 to 26 carbon atoms and having a degree of ethoxylation between 3 and 40; ethoxylated sorbitan esters having a degree of ethoxylation of from 3 to 30; cholesterol ethoxylates having HLB values of 11 to 16; ethoxylated triglycerides having HLB values of 11 to 16; alkyl ether carboxylic acids of the general formula: R—O—(—CH₂—CH₂—O—)ₙ—CH₂—COOH or cosmetically or pharmaceutically acceptable salts thereof, where R is a branched or unbranched alkyl or alkenyl radical having 5 to 30 carbon atoms and n is a number from 10 to 20; polyoxyethylene sorbitol fatty acid esters based on branched or unbranched alkanoic or alkenoic acids and having a degree of ethoxylation of from 10 to 80, for example of the sorbeth type; alkyl ether sulfates or the acids on which these sulfates are based of the general formula: R—O—(—CH₂—CH₂—O—)ₙ—SO₃—H with cosmetically or pharmaceutically acceptable cations, where R is a branched or unbranched alkyl or alkenyl radical having 5 to 30 carbon atoms and n is a number from 3 to 30; fatty alcohol propoxylates of the general formula R—O—(—CH₂—CH(CH₃)—O—)ₙ—H, where R is a branched or unbranched alkyl or alkenyl radical having 5 to 30 carbon atoms and n is a number from 10 to 30; polypropylene glycol ethers of the general formula: R—O—(—CH₂—CH(CH₃)—O—)ₙ—R′, where R and R′, independently of one another, are branched or unbranched alkyl or alkenyl radicals having 5 to 30 carbon atoms and n is a number from 10 to 40; propoxylated wool wax alcohols with HLB values of 11 to 16; fatty acid propoxylates of the general formula: R—COO—(—CH₂—CH(CH₃)—O—)ₙ—H, where R is a branched or unbranched alkyl or alkenyl radical having 5 to 30 carbon atoms and n is a number from 10 to 40; etherified fatty acid propoxylates of the general formula: R—COO—(—CH₂—CH(CH₃)—O—)ₙ—R′, where R and R′, independently of one another, are branched or unbranched alkyl or alkenyl radicals having 5 to 30 carbon atoms and n is a number from 10 to 30; esterified fatty acid propoxylates of the general formula: R—COO—(—CH₂—CH(CH₃)—O—)ₙ—C(O)—R′, where R and R′, independently of one another, are branched or unbranched alkyl or alkenyl radicals having 5 to 30 carbon atoms and n is a number from 10 to 50; polypropylene glycol glycerol fatty acid esters of saturated or unsaturated, branched or unbranched fatty acids having 6 to 26 carbon atoms and having a degree of propoxylation between 3 and 50; propoxylated sorbitan esters having a degree of propoxylation from 3 to 80; cholesterol propoxylates having HLB values of 11 to 16; propoxylated triglycerides having HLB values of 11 to 16, alkyl ether carboxylic acids of the general formula: R—O—(—CH₂—CH(CH₃)—O—)ₙ—CH₂—COOH or cosmetically or pharmaceutically acceptable salts thereof, where R is a branched or unbranched alkyl or alkenyl radical having 5 to 30 carbon atoms and n is a number from 10 to 30; alkyl ether sulfates or the acids on which these sulfates are based of the general formula: R—O—(—CH₂—CH(CH₃)—O—)ₙ—SO₃—H with cosmetically or pharmaceutically acceptable cations, where R is a branched or unbranched alkyl or alkenyl radical having 5 to 30 carbon atoms and n is a number from 1 to 30; polyglycerol methylglucose esters of the type polyglyceryl-3 methylglucose distearate; glycerol fatty acid citrates of the type glyceryl stearate citrate; water-dispersible silicone emulsifiers of the type bis PEG/PPG-16/16 PEG/PPG16/16 dimethicone+caprylic/capric triglyceride (Abil Care 85); or polyglycerol esters of the type polyglycerol-10 stearate, polyglycerol-10 laurate.

According to the invention, the polyethoxylated or polypropoxylated O/W emulsifiers used are particularly advantageously chosen from the group of substances with HLB values of 11 to 16.

It is advantageous to choose the fatty alcohol ethoxylates from the group of ethoxylated stearyl alcohols, cetyl alcohols, cetylstearyl alcohols (cetearyl alcohols). Particular preference is given to: polyethylene glycol(13) stearyl ether (steareth-13), polyethylene glycol(14) stearyl ether (steareth-14), polyethylene glycol(15) stearyl ether (steareth-15), polyethylene glycol(16) stearyl ether (steareth-16), polyethylene glycol(17) stearyl ether (steareth-17), polyethylene glycol(18) stearyl ether (steareth-18), polyethylene glycol(19) stearyl ether (steareth-19), polyethylene glycol(20) stearyl ether (steareth-20), polyethylene glycol(21) stearyl ether (steareth-21), polyethylene glycol(12) isostearyl ether (isosteareth-12), polyethylene glycol(13) isostearyl ether (isosteareth-13), polyethylene glycol(14) isostearyl ether (isosteareth-14), polyethylene glycol(15) isostearyl ether (isosteareth-15), polyethylene glycol(16) isostearyl ether (isosteareth-16), polyethylene glycol(17) isostearyl ether (isosteareth-17), polyethylene glycol(18) isostearyl ether (isosteareth-18), polyethylene glycol(19) isostearyl ether (isosteareth-19), polyethylene glycol(20) isostearyl ether (isosteareth-20), polyethylene glycol(13) cetyl ether (ceteth-13), polyethylene glycol(14) cetyl ether (ceteth-14), polyethylene glycol(15) cetyl ether (ceteth-15), polyethylene glycol(16) cetyl ether (ceteth-16), polyethylene glycol(17) cetyl ether (ceteth-17), polyethylene glycol(18) cetyl ether (ceteth-18), polyethylene glycol(19) cetyl ether (ceteth-19), polyethylene glycol(20) cetyl ether (ceteth-20), polyethylene glycol(13) isocetyl ether (isoceteth-13), polyethylene glycol(14) isocetyl ether (isoceteth-14), polyethylene glycol(15) isocetyl ether (isoceteth-15), polyethylene glycol(16) isocetyl ether (isoceteth-16), polyethylene glycol(17) isocetyl ether (isoceteth-17), polyethylene glycol(18) isocetyl ether (isoceteth-18), polyethylene glycol(19) isocetyl ether (isoceteth-19), polyethylene glycol(20) isocetyl ether (isoceteth-20), polyethylene glycol(12) oleyl ether (oleth-12), polyethylene glycol(13) oleyl ether (oleth-13), polyethylene glycol(14) oleyl ether (oleth-14), polyethylene glycol(15) oleyl ether (oleth-15), polyethylene glycol(12) lauryl ether (laureth-12), polyethylene glycol(12) isolauryl ether (isolaureth-12), polyethylene glycol(13) cetylstearyl ether (ceteareth-13), polyethylene glycol(14) cetylstearyl ether (ceteareth-14), polyethylene glycol(15) cetylstearyl ether (ceteareth-15), polyethylene glycol(16) cetylstearyl ether (ceteareth-16), polyethylene glycol(17) cetylstearyl ether (ceteareth-17), polyethylene glycol(18) cetylstearyl ether (ceteareth-18), polyethylene glycol(19) cetylstearyl ether (ceteareth-19), polyethylene glycol(20) cetylstearyl ether (ceteareth-20).

It is also advantageous to choose the fatty acid ethoxylates from the following group: polyethylene glycol(20) stearate, polyethylene glycol(21) stearate, polyethylene glycol(22) stearate, polyethylene glycol(23) stearate, polyethylene glycol(24) stearate, polyethylene glycol(25) stearate, polyethylene glycol(12) isostearate, polyethylene glycol(13) isostearate, polyethylene glycol(14) isostearate, polyethylene glycol(15) isostearate, polyethylene glycol(16) isostearate, polyethylene glycol(17) isostearate, polyethylene glycol(18) isostearate, polyethylene glycol(19) isostearate, polyethylene glycol(20) isostearate, polyethylene glycol(21) isostearate, polyethylene glycol(22) isostearate, polyethylene glycol(23) isostearate, polyethylene glycol(24) isostearate, polyethylene glycol(25) isostearate, polyethylene glycol(12) oleate, polyethylene glycol(13) oleate, polyethylene glycol(14) oleate, polyethylene glycol(15) oleate, polyethylene glycol(16) oleate, polyethylene glycol(17) oleate, polyethylene glycol(18) oleate, polyethylene glycol(19) oleate, polyethylene glycol(20) oleate.

An advantageous ethoxylated cholesterol derivative which may be used is polyethylene glycol(30) cholesteryl ether. Polyethylene glycol(25) soyasterol has also proven useful. Ethoxylated triglycerides which can be used advantageously are polyethylene glycol(60) evening primrose glycerides.

It is also advantageous to choose the polyethylene glycol glycerol fatty acid esters from the group consisting of polyethylene glycol(20) glyceryl laurate, polyethylene glycol(21) glyceryl laurate, polyethylene glycol(22) glyceryl laurate, polyethylene glycol(23) glyceryl laurate, polyethylene glycol(6) glyceryl caprate/caprinate, polyethylene glycol(20) glyceryl oleate, polyethylene glycol(20) glyceryl isostearate, polyethylene glycol(18) glyceryl oleate/cocoate.

It is likewise favorable to choose the sorbitan esters from the group consisting of polyethylene glycol(20) sorbitan monolaurate, polyethylene glycol(20) sorbitan monostearate, polyethylene glycol(20) sorbitan monoisostearate, polyethylene glycol(20) sorbitan monopalmitate, polyethylene glycol(20) sorbitan monooleate. Abil Care 85 may be chosen as silicone emulsifier. W/O emulsifiers which are optional but nevertheless advantageous according to the invention which may be used are: fatty alcohols having 8 to 30 carbon atoms; monoglycerol esters of saturated or unsaturated, branched or unbranched alkanecarboxylic acids or hydroxyalkanecarboxylic acids with a chain length of from 8 to 24, in particular 12 to 18, carbon atoms; diglycerol esters of saturated or unsaturated, branched or unbranched alkanecarboxylic acids or hydroxyalkanecarboxylic acids with a chain length of from 8 to 24, in particular 12 to 18, carbon atoms; monoglycerol ethers of saturated and/or unsaturated, branched and/or unbranched alcohols with a chain length of from 8 to 24, in particular 12 to 18, carbon atoms, diglycerol ethers of saturated or unsaturated, branched or unbranched alcohols with a chain length of from 8 to 24, in particular 12 to 18, carbon atoms; propylene glycol esters of saturated or unsaturated, branched or unbranched alkanecarboxylic acids or hydroxyalkanecarboxylic acids with a chain length of from 8 to 24, in particular 12 to 18, carbon atoms; and sorbitan esters of saturated or unsaturated, branched or unbranched alkanecarboxylic acids or hydroxyalkanecarboxylic acids with a chain length of from 8 to 24, in particular 12 to 18, carbon atoms.

Particularly advantageous W/O emulsifiers are glyceryl monostearate, glyceryl monoisostearate, glyceryl linoleate, triglycerol diisostearate, glyceryl monomyristate, glyceryl monooleate, diglyceryl monostearate, diglyceryl monoisostearate, propylene glycol monostearate, propylene glycol monoisostearate, propylene glycol monocaprylate, propylene glycol monolaurate, sorbitan monoisostearate, sorbitan monolaurate, sorbitan monocaprylate, methyl propanediol, sucrose distearate, cetyl alcohol, stearyl alcohol, arachidyl alcohol, behenyl alcohol, isobehenyl alcohol, selachyl alcohol, chimyl alcohol, polyethylene glycol(2) stearyl ether (steareth-2), glyceryl monolaurate, glyceryl monocaprinate, glyceryl monocaprylate, polyglyceryl-3 methylglucose distearate, PEG-45/dodecyl glycol copolymer, methoxy-PEG-22-dodecyl glycol copolymer, methylglucose sesquistearate, polyglyceryl-2 dipolyhydroxystearate, cetyl dimethicone copolyol, alkyl methicone copolyol, alkyl dimethicone ethoxy glucoside, PEG-40 sorbitan perisostearate, PEG-30 dipolyhydroxystearate.

According to the invention, it is possible to keep the total content of emulsifiers less than 15% by weight, based on the total weight of the preparations according to the invention. It is preferred to keep the total content of emulsifiers less than 10% by weight, in particular less than 8% by weight, based on the total weight of the preparations.

Skin moisturizers which can be used advantageously are glycerol, chitosan, Fucogel, 2-methylpropanediol, lactic acid, propylene glycol, dipropylene glycol, butylene glycol, mannitol, polyethylene glycol, acids and salts thereof, such as sodium pyrrolidonecarboxylic acid, glycine, hyaluronic acid, urea, sodium, potassium, magnesium and calcium salts. Glycerol on its own and in combination with one of the abovementioned moisturizers is particularly advantageous.

It can be shown that phospholipid-containing, low-viscosity (atomizable) O/W emulsions containing skin-moisturizing ingredients have excellent properties with regard to the moisturization, smoothing and reduction in flakiness of the skin.

The following emulsifiers are particularly advantageously used. Ethoxylated fatty acid esters and fatty acid glycerides, in particular PEG-50 hydrogenated castor oil isostearate; PEG-45 palm kernel oil glycerides; ethoxylated sorbitan esters, in particular PEG-20 sorbitan isostearate, and PEG-20 sorbitan monooleate; polyglycerol esters, in particular polyglycerol-10 stearate and polyglycerol-10 laurate; ethoxylated glycerol esters, in particular PEG-20 glyceryl laurate and PEG-20 glyceryl stearate; fatty acid ethoxylates, in particular PEG-20 monostearate; and fatty alchol ethoxylates, in particular ceteareth-12 and oleth-15.

The oil phase of the preparations according to the invention is advantageously chosen from the group of esters of saturated or unsaturated, branched or unbranched alkanecarboxylic acids with a chain length of from 3 to 30 carbon atoms and saturated or unsaturated, branched or unbranched alcohols with a chain length of from 3 to 30 carbon atoms, from the group of esters of aromatic carboxylic acids and saturated or unsaturated, branched and/or unbranched alcohols with a chain length of from 3 to 30 carbon atoms. Such ester oils can then advantageously be chosen from the group consisting of isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl palmitate, 2-ethylhexyl laurate, 2-hexyldecyl stearate, 2-octyidodecyl palmitate, oleyl oleate, oleyl erucate, erucyl oleate, erucyl erucate, and synthetic, semisynthetic and natural mixtures of such esters, e.g. jojoba oil.

The oil phase can also advantageously be chosen from the group of branched and unbranched hydrocarbons and hydrocarbon waxes, silicone oils, dialkyl ethers, the group of saturated or unsaturated, branched or unbranched alcohols, and fatty acid triglycerides, namely the triglycerol esters of saturated or unsaturated, branched or unbranched alkanecarboxylic acids with a chain length of from 8 to 24, in particular 12 to 18, carbon atoms. The fatty acid triglycerides can, for example, be chosen advantageously from the group of synthetic, semisynthetic and natural oils, e.g., olive oil, sunflower oil, soybean oil, peanut oil, rapeseed oil, almond oil, palm oil, coconut oil, palm kernel oil, and the like.

For example, dicaprylyl carbonate, butylene glycol caprylate/caprate, di-C₁₂₋₁₃ alkyl tartrate, caprylic/capric diglyceryl succinate, caprylic/capric triglyceride, octyidodecanol, cetearyl isononanoate, cocoglyceride, mineral oil, hydrogenated polydecene, isoeicosane, dioctylcyclohexane, squalane, squalene, C₁₂₋₁₅-alkyl benzoate, and mixtures of these oil phases are advantageous.

In addition, waxes may also be a constituent of the oil phase, such as, for example, methyl palmitate, cetyl palmitate, C₂₀₋₄₀-alkyl stearate, C₁₈₋₃₆-acid triglyceride. In such cases, the preparations according to the invention can also be produced, if appropriate, as microdispersions of solid wax particles. Any desired mixtures of such oil and wax components can also be used advantageously for the purposes of the present invention.

The oil phase can advantageously also have a content of cyclic or linear silicone oils or consist entirely of such oils, although it is preferred to use an additional content of other oil phase components apart from the silicone oil or the silicone oils. Cyclomethicone (octamethylcyclotetrasiloxane) is advantageously used as silicone oil to be used according to the invention. However, other silicone oils can also be used advantageously for the purposes of the present invention, for example, hexamethylcyclotrisiloxane, polydimethylsiloxane, and poly(methylphenylsiloxane).

For the phospholipid-containing low-viscosity (atomizable) O/W emulsions according to the invention, the following % by weight amounts are preferred, in each case based on the total weight of the preparations:

| | |
|---|---|
| Phospholipid: | 0.01 to 10%, in particular 0.1 to 5.0% |
| O/W emulsifier: | 0.01 to 60%, in particular 0.1 to 10% |
| W/O emulsifier: | 0.01 to 60%, in particular 0.1 to 10% |
| Oil phase: | 0.01 to 50%, in particular 0.1 to 30% |
| Additives for the oil phase: | 0.01 to 20%, in particular 0.1 to 15% |
| Additives for the water phase: | 0.01 to 80%, in particular 0.1 to 60% |
| Water | ad 100% |

The phospholipid/(O/W emulsifier/W/O emulsifier) weight ratio in the preparations according to the invention can vary, e.g., from 1:30 to 2:1. Preferably, the phospholipid/OW emulsifier ratio is 1:15 to 1:1. The phospholipid/OW emulsifier ratio is particularly preferably 1:6 to 1:1.3. Here, the ratio of (phospholipid+W/O emulsifier) to O/W emulsifier can vary, e.g., 1:30 to 2:1. The (phospholipid+W/O emulsifier) to O/W emulsifier ratio is preferably 1:6 to 1:1.3.

The microemulsion gels according to the invention advantageously comprise electrolytes, in particular one or more salts with the following anions: chlorides, and also inorganic oxo element anions, of these in particular sulfates, carbonates, phosphates, borates, and aluminates. Electrolytes based on organic anions can also be used advantageously, for example, lactates, acetates, benzoates, propionates, tartrates, citrates, and others besides. Comparable effects can also be achieved by ethylenediaminetetraacetic acid and salts thereof.

The cations of the salts used are preferably ammonium, alkylammoniun, alkali metal, alkaline earth metal, magnesium, iron or zinc ions. It goes without saying that only physiologically safe electrolytes should be used in cosmetics. Specific medicinal applications of the microemulsions according to the invention may, on the other hand, at least in principle, necessitate the use of electrolytes which should not be used without medical supervision.

Particular preference is given to sodium and potassium chloride, sodium and potassium bromide, magnesium and calcium chloride, magnesium and calcium bromide, zinc sulfate, and mixtures thereof. Salt mixtures as occur in the natural salt of the Dead Sea are likewise advantageous. All of these salts are advantageous since they stimulate endogenous lipid synthesis.

The concentration of the electrolyte or of the electrolytes should be, for example, about 0.1 to 10.0% by weight, particularly advantageously about 0.3 to 8.0% by weight, based on the total weight of the preparation.

The preparations described below may be phospholipid-containing, low-viscosity (atomizable) O/W emulsions according to the invention.

If the preparations according to the invention are bases for cosmetic deodorants/antiperspirants, then all of the customary active ingredients may be used advantageously, for example odor concealers, such as customary perfume constituents, odor absorbers, for example, the sheet silicates described in the patent laid-open specification DE-P 40 09 347, and of these, in particular, montmorillonite, kaolinite, ilite, beidellite, nontronite, saponite, hectorite, bentonite, smectite, and also, for example, zinc salts of ricinoleic acid. Antimicrobial agents are likewise suitable to be incorporated into the microemulsions according to the invention. Advantageous substances are, for example, 2,4,4′-trichloro-2′-hydroxydiphenyl ether (Irgasan), 1,6-di(4-chlorophenylbiguanido)hexane (chlorhexidine), 3,4,4′-trichlorocarbanilide, quaternary ammonium compounds, oil of cloves, mint oil, oil of thyme, triethyl citrate, farnesol (3,7,11-trimethyl-2,6,10-dodecatrien-1-ol), and the active agents described in the patent laid-open specifications DE-37 40 186, DE-39 38 140, DE-42 04 321, DE-42 29 707, DE-42 29 737, DE-42 37 081, DE-43 09 372, and DE-43 24 219.

The customary antiperspirant active ingredients can likewise be used advantageously in the phospholipid-containing, low-viscosity O/W emulsions according to the invention, in particular astringents, for example basic aluminum chlorides.

The cosmetic deodorants according to the invention can be in the form of aerosols, i.e., preparations which can be sprayed from aerosol containers, squeezable bottles or by a pump device, or in the form of liquid compositions which can be applied by means of roll-on devices, but also in the form of phospholipid-containing, low-viscosity O/W emulsions which can be applied from normal bottles and containers.

Suitable propellants for cosmetic deodorants according to the invention which can be sprayed from aerosol containers are the customary known readily volatile, liquefied propellants, for example, hydrocarbons (propane, butane, isobutane), which can be used on their own or in a mixture with one another. Compressed air can also be used advantageously.

The person skilled in the art is of course aware that there are propellant gases which are nontoxic per se which would in principle be suitable for the present invention but which nevertheless have to be dispensed with due to an unacceptable impact on the environment or other accompanying circumstances, in particular chlorofluorocarbons (CFCs).

Moreover, it has surprisingly been found that, when using propellants which are soluble in the oil phase, i.e., for example, customary propane/butane mixtures, the phospholipid-containing, low-viscosity (atomizable) O/W emulsions according to the invention are not simply sprayed as aerosol droplets, but develop to give finely bubbled, rich foams as soon as such systems containing such propellants experience a pressure release. Such after-foaming preparations are therefore likewise regarded as being advantageous embodiments of the present invention with an independent inventive step.

When using propellants which are insoluble in the oil phase, the preparations according to the invention are sprayed as aerosol droplets.

Also favorable are those cosmetic and dermatological preparations which are present in the form of a sunscreen. Preferably, besides the active ingredient combinations according to the invention, these additionally comprise at least one UVA filter substance, UVB filter substance, or inorganic pigment.

It is, however, also advantageous for the purposes of the present inventions to create those cosmetic and dermatological preparations whose main purpose is not protection against sunlight but which nevertheless have a content of UV protection substances. Thus, for example, UV-A or UV-B filter substances are usually incorporated into day creams.

Preparations according to the invention can advantageously comprise substances which absorb UV radiation in the UVB region, the total amount of the filter substances being, for example, 0.1% by weight to 30% by weight, preferably 0.5 to 10% by weight, in particular 1 to 9% by weight, based on the total weight of the preparations, in order to provide cosmetic and/or dermatological preparations which protect the skin from the entire range of ultraviolet radiation. They can also be used as sunscreens.

Preferred inorganic pigments are metal oxides and other metal compounds which are insoluble or sparingly soluble in water, in particular oxides of titanium (TiO₂), zinc (ZnO), iron (e.g. Fe₂O₃), zirconium (ZrO₂), silicon (SiO₂), manganese (e.g., MnO), aluminum (Al₂O₃), cerium (e.g., Ce₂O₃), mixed oxides of the corresponding metals, and mixtures of such oxides.

For the purposes of the present invention, such pigments may advantageously be surface treated (“coated”), the intention being to form or retain, for example, an amphiphilic or hydrophobic character. This surface treatment can involve providing the pigments with a thin hydrophobic layer by processes known per se.

Advantageous according to the invention are, for example, titanium dioxide pigments which have been coated with octylsilanol. Suitable titanium dioxide particles are available under the trade name T805 from Degussa. Also particularly advantageous are TiO₂ pigments coated with aluminum stearate, e.g., those available under the trade name MT 100 T from TAYCA.

A further advantageous coating of the inorganic pigments consists of dimethylpolysiloxane (also: dimethicone), a mixture of completely methylated, linear siloxane polymers which have been terminally blocked with trimethylsiloxy units. Particularly advantageous for the purposes of the present invention are zinc oxide pigments which have been coated in this way.

Also advantageous is a coating of the inorganic pigments with a mixture of dimethylpolysiloxane, in particular dimethylpolysiloxane having an average chain length of from 200 to 350 dimethylsiloxane units, and silica gel, which is also referred to as simethicone. In particular, it is advantageous for the inorganic pigments to be additionally coated with aluminum hydroxide or aluminum oxide hydrate (also: alumina, CAS No.: 1333-84-2). Particularly advantageous are titanium dioxides which have been coated with simethicone and alumina, it also being possible for the coating to comprise water. An example thereof is the titanium dioxide available under the trade name Eusolex T2000 from Merck.

An advantageous organic pigment for the purposes of the present invention is the 2,2′-methylene-bis(6-(2H-benzotriazol-2-yl)-4-(1,1,3,3,-tetramethylbutyl)phenol) [INCI: Bis-octyltriazole], which is available under the trade name Tinosorb® M from CIBA-Chemikalien GmbH.

Advantageous UV-A filter substances for the purposes of the present invention are dibenzoylmethane derivatives, in particular 4-(tert-butyl)-4′-methoxydibenzoylmethane (CAS No.: 70356-09-1), which is sold by Givaudan under the name Parsol® 1789 and by Merck under the trade name Eusolex® 9020.

Advantageous UV filter substances for the purposes of the present invention are also so-called broadband filters, i.e. filter substances which absorb both UV-A and also UV-B radiation.

Advantageous broadband filters or UV-B filter substances are, for example, bis(resorcinyltriazine) derivatives. Particular preference is given to 2,4-bis{[4-(2-ethylhexyloxy)-2-hydroxylphenyl}-6-(4-methoxyphenyl)-1,3,5-triazine (INCI: AnisoTriazine), which is available under the trade name Tinosorb® S from CIBA-Chemikalien GmbH.

For the purposes of the present invention, particularly advantageous preparations which are characterized by high or very high UV-A protection preferably comprise two or more UV-A and/or broadband filters, in particular dibenzoylmethane derivatives [for example 4-(tert-butyl)₄′-methoxydibenzoylmethane], benzotriazole derivatives [for example 2,2′-methylenebis(6-(2H-benzotriazol-2-yl)-4-(1,1,3,3-tetramethylbutyl)phenol)], phenylene-1,4-bis(2-benzimidazyl)-3,3′-5,5′-tetrasulfonic acid and/or its salts, 1,4-di(2-oxo-10-sulfo-3-bornylidenemethyl)benzene and/or salts thereof and/or 2,4-bis{[4-(2-ethylhexyloxy)-2-hydroxylphenyl}-6-(4-methoxyphenyl)-1,3,5-triazine, in each case individually or in any combinations with one another.

Other UV filter substances which have the structural formula: 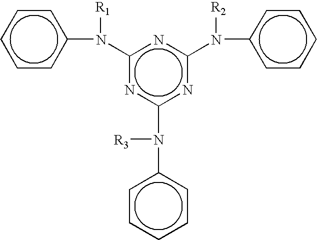
are also advantageously UV filter substances for the purposes of the present invention, for example, the S-triazine derivatives described in European laid-open specification EP 570 838 A1, whose chemical structure is expressed by the generic formula: 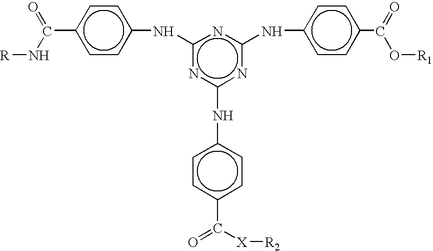
where:
R is a branched or unbranched C₁-C₁₈-alkyl radical, a C₅-C₁₂-cycloalkyl radical, optionally substituted by one or more C₁-C₄-alkyl groups,
X is an oxygen atom or an NH group,
R₁ is a branched or unbranched C₁-C₁₈-alkyl radical, a C₅-C₁₂-cycloalkyl radical, optionally substituted by one or more C₁-C₄-alkyl groups, or a hydrogen atom, an alkali metal atom, an ammonium group, or a group of the formula: 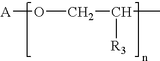
   where:
A is a branched or unbranched C₁-C₁₈-alkyl radical, a C₅-C₁₂-cycloalkyl or aryl radical, optionally substituted by one or more C₁-C₄-alkyl groups,
R₃ is a hydrogen atom or a methyl group,
n is a number from 1 to 10,
R₂ is a branched or unbranched C₁-C₁₈-alkyl radical, a C₅-C₁₂-cycloalkyl radical, optionally substituted by one or more C₁-C₄-alkyl groups, when X is the NH group, and
   a branched or unbranched C₁-C₁₈-alkyl radical, a C₅-C₁₂-cycloalkyl radical, optionally substituted by one or more C₁-C₄-alkyl groups, or a hydrogen atom, an alkali metal atom, an ammonium group, or a group of the formula: 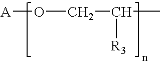
      where:
A is a branched or unbranched C₁-C₁₈-alkyl radical, a C₅-C₁₂-cycloalkyl or aryl radical, optionally substituted by one or more C₁-C₄-alkyl groups,
R₃ is a hydrogen atom or a methyl group,
n is a number from 1 to 10,
   when X is an oxygen atom.

A particularly preferred UV filter substance for the purposes of the present invention is also an asymmetrically substituted s-triazine, the chemical structure of which is expressed by the formula: 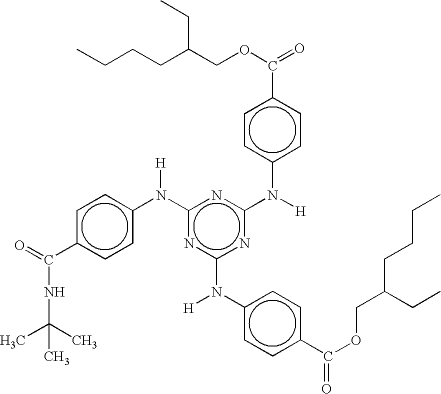
which is also referred to below as dioctylbutylamidotriazone (INCI: Dioctylbutamidotriazone), and is available under the trade name UVA SORB HEB from Sigma 3V.

Also advantageous for the purposes of the present invention is a symmetrically substituted s-triazine, tris(2-ethylhexyl) 4,4′,4″-(1,3,5-triazine-2,4,6-triyltriimino)-trisbenzoate, synonym: 2,4,6-tris[anilino(p-carbo-2′-ethyl-1′-hexyloxy)]-1,3,5-triazine (INCI: Octyl Triazone), which is sold by BASF Aktiengesellschaft under the trade name UVINUL® T 150.

European laid-open specification 775 698 also describes preferred bisresorcinoltriazine derivatives, the chemical structure of which is expressed by the generic formula: 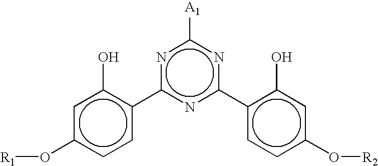
where R₁, R₂ and A₁ represent very different organic radicals.

Also advantageous for the purposes of the present invention are 2,4-bis{[4-(3-sulfonato)-2-hydroxypropyloxy)-2-hydroxylphenyl}-6-(4-methoxyphenyl)-1,3,5-triazine sodium salt, 2,4-bis{[4-(3-(2-propyloxy)-2-hydroxypropyloxy)-2-hydroxylphenyl}-6-(4-methoxyphenyl)-1,3,5-triazine, 2,4-bis{[4-(2-ethylhexyloxy)-2-hydroxy]phenyl}-6-[4-(2-methoxyethylcarboxyl)phenylamino]-1,3,5-triazine, 2,4-bis{[4-(3-(2-propyloxy)-2-hydroxypropyloxy)-2-hydroxylphenyl}-6-[4-(2-ethylcarboxyl)phenylamino]-1,3,5-triazine, 2,4-bis{[4-(2-ethylhexyloxy)-2-hydroxylphenyl}-6-(1-methylpyrrol-2-yl)-1,3,5-triazine, 2,4-bis{[4-tris(trimethylsiloxysilylpropyloxy)-2-hydroxylphenyl}-6-(4-methoxyphenyl)-1,3,5-triazine, 2,4-bis{[4-(2″-methylpropenyloxy)-2-hydroxylphenyl}-6-(4-methoxyphenyl)-1,3,5-triazine, and 2,4-bis{[4-(1′,1′,1′,3′,5′,5′,5′-heptamethylsiloxy-2″-methylpropyloxy)-2-hydroxy]phenyl}-6-(4-methoxyphenyl)-1,3,5,-triazine.

An advantageous broadband filter for the purposes of the present invention is 2,2′-methylenebis(6-(2H-benzotriazol-2-yl)-4-(1,1,3,3-tetramethylbutyl)phenol, which is available under the trade name Tinosorb® M from CIBA-Chemikalien GmbH. Another advantageous broadband filter for the purposes of the present invention is 2-(2H-benzotriazol-2-yl)-4-methyl-6-[2-methyl-3-[1,3,3,3-tetramethyl-1-[(trimethylsilyl)oxy]disiloxanyl]propyl]phenol (CAS No.: 155633-54-8) with the INCI name Drometrizole Trisiloxane.

The UVB and/or broadband filters may be oil-soluble or water-soluble. Examples of advantageous oil-soluble UVB and/or broadband filter substances are: 3-benzylidenecamphor derivatives, preferably 3-(4-methylbenzylidene)camphor or 3-benzylidenecamphor; 4-aminobenzoic acid derivatives, preferably 2-ethylhexyl 4-(dimethylamino)benzoate or amyl 4-(dimethylamino)benzoate; 2,4,6-trianilino(p-carbo-2′-ethyl-1′-hexyloxy)-1,3,5-triazine; esters of benzalmalonic acid, preferably di(2-ethylhexyl) 4-methoxybenzalmalonate; esters of cinnamic acid, preferably 2-ethylhexyl 4-methoxycinnamate or isopentyl 4-methoxycinnamate; derivatives of benzophenone, preferably 2-hydroxy-4-methoxybenzophenone, 2-hydroxy-4-methoxy-4′-methylbenzophenone, or 2,2′-dihydroxy-4-methoxybenzophenone; 3-(4-2,2bis(ethoxycarbonylvinyl)phenoxy)propenyl)methoxysiloxane/dimethylsiloxane copolymer which is obtainable, for example, under the trade name Parsol® SLX from Hoffmann La Roche; and UV filters bonded to polymers.

Examples of advantageous water-soluble UVB and/or broadband filter substances are: salts of 2-phenylbenzimidazole-5-sulfonic acid, such as its sodium, potassium, or its triethanolammonium salt, and the sulfonic acid itself; sulfonic acid derivatives of 3-benzylidenecamphor, such as, for example, 4-(2-oxo-3-bornylidenemethyl)benzenesulfonic acid, 2-methyl-5-(2-oxo-3-bornylidenemethyl)-sulfonic acid and its salts; phenylene-1,4-bis(2-benzimidazyl)-3,3′-5,5′-tetrasulfonic acid and its salts, particularly the corresponding sodium, potassium or triethanolammonium salts, in particular the phenylene-1,4-bis(2-benzimidazyl)-3,3′-5,5′-tetrasulfonic acid bis-sodium salt with the INCI name Bisimidazylate (CAS No.: 180898-37-7), which is available, for example, under the trade name Neo Heliopan AP from Haarmann & Reimer; further advantageous UV-A filter substances are phenylene-1,4-bis(2-benzimidazyl)-3,3′-5,5′-tetrasulfonic acid and its salts, particularly the corresponding sodium, potassium, or triethanolammonium salts, in particular the phenylene-1,4-bis(2-benzimidazyl)-3,3′-5,5′-tetrasulfonic acid bis-sodium salt with the INCI name Bisimidazylate, which is available, for example, under the trade name Neo Heliopan AP from Haarmann & Reimer; 1,4-di(2-oxo-10-sulfo-3-bornylidenemethyl)benzene (also: 3,3′-(1,4-phenylenedimethylene)bis(7,7-dimethyl-2-oxobicyclo[2.2.1]hept-1-ylmethanesulfonic acid) and salts thereof (particularly the corresponding 10-sulfato compounds, in particular the corresponding sodium, potassium or triethanolammonium salt), which is also referred to as benzene-1,4-d i(2-oxo-3-bornylidenemethyl-10-sulfon ic acid). Benzene-1,4-d i(2-oxo-3-bornylidenemethyl-10-sulfonic acid) has the INCI name Terephthalidene Dicamphor Sulfonic Acid (CAS No.: 90457-82-2) and is available, for example, under the trade name Mexoryl SX from Chimex;

Another advantageous broadband filter for the purposes of the present invention is 2-(2H-benzotriazol-2-yl)-4-methyl-6-[2-methyl-3-[1,3,3,3-tetramethyl-1-[(trimethylsilyl)oxy]disiloxanyl]propyl]phenol (CAS No.: 155633-54-8) with the INCI name Drometrizole Trisiloxane, which is available under the trade name Mexoryl® XL from Chimex.

A further photoprotective filter substance to be used advantageously according to the invention is ethylhexyl 2-cyano-3,3-diphenylacrylate (octocrylene), which is available from BASF under the name Uvinul® N 539.

It may also be of considerable advantage to use polymer-bound or polymeric UV filter substances in preparations according to the present invention, in particular those as are described in WO-A-92/20690.

In addition, it may in some instances be advantageous to incorporate, in accordance with the invention, further UV-A or UV-B filters into cosmetic or dermatological preparations, for example, certain salicylic acid derivatives, such as 4-isopropylbenzyl salicylate, 2-ethylhexyl salicylate (=octyl salicylate), and homomenthyl salicylate.

The list of UV filters mentioned which can be used in the context of the present invention is not of course intended to be limiting.

In addition, it may in some instances be advantageous to incorporate film formers into the cosmetic or dermatological preparations according to the invention, for example, in order to improve the water resistance of the preparations or to increase the UV protection performance (UV-A and UV-B boosting). Either water-soluble or dispersible or fat-soluble film formers are suitable, in each case individually or in combination with one another.

Advantageous water-soluble or dispersible film formers are, for example, polyurethanes (e.g., the Avalure® grades from Goodrich), dimethicone copolyolpolyacrylates (Silsoft Surface® from Witco Organo Silicones Group), PVPNA (VA=vinyl acetate) copolymer (Luviscol VA 64 Powder from BASF) etc.

Advantageous fat-soluble film formers are, for example, the film formers from the group of polymers based on polyvinylpyrrolidone (PVP)

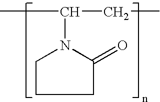

Particular preference is given to copolymers of polyvinylpyrrolidone, for example, the PVP hexadecene copolymer and the PVP eicosene copolymer, which are available under the trade names Antaron V216 and Antaron V220 from GAF Chemicals Cooperation, and also Tricontayl PVP and the like.

Cosmetic and/or dermatological preparations according to the invention may also comprise inorganic pigments which are customarily used in cosmetics for protecting the skin against UV rays. These are oxides of titanium, zinc, iron, zirconium, silicon, manganese, aluminum, cerium, and mixtures thereof, and also modifications in which the oxides are the active agents. They are particularly preferably pigments based on titanium dioxide. The amounts specified for the abovementioned combinations may be used.

A surprising property of the present invention is that preparations according to the invention are very good vehicles for cosmetic or dermatological active ingredients into the skin, advantageous active ingredients being antioxidants which can protect the skin against oxidative stress.

According to the invention, the preparations advantageously comprise one or more antioxidants. Favorable, but nevertheless optional, antioxidants to be used are all antioxidants which are customary or suitable for cosmetic and dermatological applications. In this connection, it is advantageous to use antioxidants as the sole class of active ingredient when, for example, a cosmetic or dermatological application is at the forefront, such as controlling the oxidative stress of the skin. It is, however, also favorable to provide the preparations according to the invention with a content of one or more antioxidants if the preparations are to serve another purpose, e.g. as deodorants or sunscreens.

The antioxidants are advantageously chosen from the group consisting of amino acids (e.g., glycine, histidine, tyrosine, and tryptophan) and derivatives thereof, imidazoles (e.g., urocanic acid) and derivatives thereof, peptides, such as D,L-carnosine, D-carnosine, L-carnosine, and derivatives thereof (e.g., anserine), carotenoids, carotenes (e.g,. α-carotene, β-carotene, and lycopene), and derivatives thereof, lipoic acid and derivatives thereof (e.g., dihydrolipoic acid), aurothioglucose, propylthiouracil, and other thiols (e.g., thioredoxin, glutathione, cysteine, cystine, cystamine, and the glycosyl, N-acetyl, methyl, ethyl, propyl, amyl, butyl, and lauryl, palmitoyl, oleyl, γ-linoleyl, cholesteryl, and glyceryl esters thereof), and also salts thereof, dilauryl thiodipropionate, distearyl thiodipropionate, thiodipropionic acid, and derivatives thereof (esters, ethers, peptides, lipids, nucleotides, nucleosides, and salts), and also sulfoximine compounds (e.g., buthionine sulfoximines, homocysteine sulfoximine, buthionine sulfones, penta-, hexa-, and heptathionine sulfoximine) in very low tolerated doses (e.g., μmol to μmol/kg), and also (metal) chelating agents (e.g., α-hydroxy fatty acids, palmitic acid, phytic acid, and lactoferrin), α-hydroxy acids (e.g., citric acid, lactic acid, and malic acid), humic acid, bile acid, bile extracts, bilirubin, biliverdin, EDTA, EGTA, and derivatives thereof, unsaturated fatty acids and derivatives thereof (e.g., γ-linolenic acid, linoleic acid, and oleic acid), folic acid and derivatives thereof, ubiquinone and ubiquinol and derivatives thereof, vitamin C and derivatives (e.g,. ascorbyl palmitate, Mg ascorbyl phosphate, ascorbyl acetate), tocopherols, and derivatives (e.g., vitamin E acetate), vitamin A and derivatives (vitamin A palmitate), and coniferyl benzoate of benzoin resin, rutinic acid and derivatives thereof, ferulic acid and derivatives thereof, butylhydroxytoluene, butylhydroxyanisole, nordihydroguaiacic acid, nordihydroguaiaretic acid, trihydroxybutyrophenone, uric acid, and derivatives thereof, mannose and derivatives thereof, zinc and derivatives thereof (e.g. ZnO, ZnSO₄), selenium and derivatives thereof (e.g., selenomethionine), stilbenes and derivatives thereof (e.g., stilbene oxide and trans-stilbene oxide) and the derivatives (salts, esters, ethers, sugars, nucleotides, nucleosides, peptides, and lipids) of these said active ingredients which are suitable according to the invention.

For the purposes of the present invention, water-soluble antioxidants may be used particularly advantageously.

A surprising property of the preparations according to the invention is that they are very good vehicles for cosmetic or dermatological active ingredients into the skin, preferred active ingredients being antioxidants which can protect the skin against oxidative stress. Preferred antioxidants here are vitamin E and derivatives thereof, and vitamin A and derivatives thereof.

The amount of antioxidants (one or more compounds) in the preparations is preferably 0.001 to 30% by weight, particularly preferably 0.05 to 20% by weight, in particular 0.1 to 10% by weight, based on the total weight of the preparation.

If vitamin E and/or derivatives thereof are the antioxidant or the antioxidants, it is advantageous to choose their particular concentrations from the range from 0.001 to 10% by weight, based on the total weight of the formulation.

If vitamin A or vitamin A derivatives, or carotenes or derivatives thereof are the antioxidant or the antioxidants, it is advantageous to choose their particular concentrations from the range from 0.001 to 10% by weight, based on the total weight of the formulation.

According to the invention, the active ingredients (one or more compounds) can also very advantageously be chosen from the group of lipophilic active ingredients, in particular from the following group: acetylsalicylic acid, atropine, azulene, hydrocortisone and derivatives thereof, e.g., hydrocortisone-17 valerate, vitamins, e.g., ascorbic acid and derivatives thereof, vitamins of the B and D series, very favorably vitamin B₁, vitamin B₁₂, vitamin D₁, but also bisabolol, unsaturated fatty acids, namely the essential fatty acids (often also called vitamin F), in particular gamma-linolenic acid, oleic acid, eicosapentanoic acid, docosahexanoic acid and derivatives thereof, chloramphenicol, caffeine, prostaglandins, thymol, camphor, extracts or other products of a vegetable and animal origin, e.g., evening primrose oil, borage oil or currant seed oil, fish oils, cod-liver oil and also ceramides and ceramide-like compounds, etc.

It is also advantageous to choose the active ingredients from the group of refatting substances, for example purcellin oil, Eucerit®, and Neocerit®.

The active ingredient or ingredients are particularly advantageously chosen from the group of NO synthase inhibitors, particularly if the preparations according to the invention are to be used for the treatment and prophylaxis of the symptoms of intrinsic and/or extrinsic skin aging and for the treatment and prophylaxis of the harmful effects of ultraviolet radiation on the skin. A preferred NO synthase inhibitor is nitroarginine.

The active ingredient or ingredients is/are further advantageously chosen from the group which includes catechins and bile esters of catechins and aqueous or organic extracts from plants or parts of plants which have a content of catechins or bile esters of catechins, such as, for example, the leaves of the theaceae plant family, in particular of the species Camellia sinensis (green tea). Their typical ingredients (such as, for example, polyphenols or catechins, caffeine, vitamins, sugars, minerals, amino acids, and lipids) are particularly advantageous.

Catechins are a group of compounds which are to be regarded as hydrogenated flavones or anthocyanidins and are derivatives of “catechin” (catechol, 3,3′,4′,5,7-flavanpentol, 2-(3,4-dihydroxyphenyl)chroman-3,5,7-triol). Epicatechin ((2R,3R)-3,3′,4′,5,7-flavanpentol) is also an advantageous active ingredient for the purposes of the present invention.

Also advantageous are plant extracts with a content of catechins, in particular extracts of green tea, such as, for example, extracts from leaves of the plants of the species Camellia spec., very particularly of the tea types Camellia sinensis, C. assamica, C. taliensis, and C. irrawadiensis and hybrids of these with, for example, Camellia japonica.

Preferred active ingredients are also polyphenols and catechins from the group consisting of (−)-catechin, (+)-catechin, (−)-catechin gallate, (−)-gallocatechin gallate, (+)-epicatechin, (−)-epicatechin, (−)-epicatechin gallate, (−)-epigallocatechin, and (−)-epigallocatechin gallate.

Flavone and its derivatives (also often collectively called “flavones”) are also advantageous active ingredients for the purposes of the present invention. They are characterized by the following basic structure (substitution positions are shown):

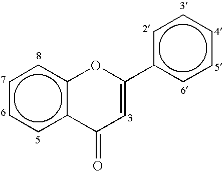

Some of the more important flavones which can also preferably be used in preparations according to the invention are given in the table below:

| | OH substitution positions | | | | | | | |
|---|---|---|---|---|---|---|---|---|
| | 3 | 5 | 7 | 8 | 2′ | 3′ | 4′ | 5′ |
| Flavone | − | − | − | − | − | − | − | − |
| Flavonol | + | − | − | − | − | − | − | − |
| Chrysin | − | + | + | − | − | − | − | − |
| Galangin | + | + | + | − | − | − | − | − |
| Apigenin | − | + | + | − | − | − | + | − |
| Fisetin | + | − | + | − | − | + | + | − |
| Luteolin | − | + | + | − | − | + | + | − |
| Kaempferol | + | + | + | − | − | − | + | − |
| Quercetin | + | + | + | − | − | + | + | − |
| Morin | + | + | + | − | + | − | + | − |
| Robinetin | + | − | + | − | − | + | + | + |
| Gossypetin | + | + | + | + | − | + | + | − |
| Myricetin | + | + | + | − | − | + | + | + |

In nature, flavones are usually in glycosylated form. According to the invention, the flavonoids are preferably chosen from the group of substances of the generic structural formula: 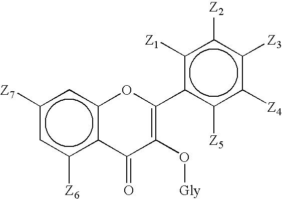
where Z₁ to Z₇, independently of one another, are chosen from the group consisting of H, OH, alkoxy, and hydroxyalkoxy groups, where the alkoxy and hydroxyalkoxy groups can be branched or unbranched and may have 1 to 18 carbon atoms, and where Gly is chosen from the group of mono- and oligoglycoside radicals.

According to the invention, the flavonoids can, however, also be chosen advantageously from the group of substances of the generic structural formula: 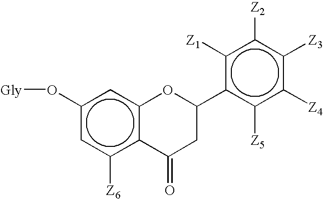
where Z₁ to Z₆, independently of one another, are chosen from the group consisting of H, OH, alkoxy and hydroxyalkoxy groups, where the alkoxy and hydroxyalkoxy groups may be branched or unbranched and have 1 to 18 carbon atoms, and where Gly is chosen from the group of mono- and oligoglycoside radicals.

Preferably, such structures can be chosen from the group of substances of the generic structural formula: 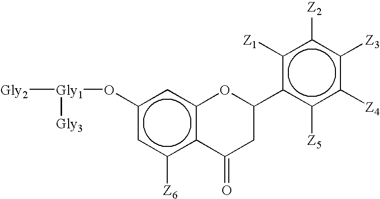
where Gly₁, Gly₂ and Gly₃, independently of one another, are monoglycoside radicals or. Gly₂ and Gly₃ may also, individually or together, represent saturations by hydrogen atoms.

Preferably, Gly₁, Gly₂ and Gly₃, independently of one another, are chosen from the group of hexosyl radicals, in particular the rhamnosyl radicals and glucosyl radicals. However, other hexosyl radicals, for example allosyl, altrosyl, galactosyl, gulosyl, idosyl, mannosyl, and talosyl, can also be used advantageously in some circumstances. It may also be advantageous according to the invention to use pentosyl radicals.

Advantageously, Z₁ to Z₅, independently of one another, are chosen from the group consisting of H, OH, methoxy, ethoxy, and 2-hydroxyethoxy, and the flavone glycosides have the structure: 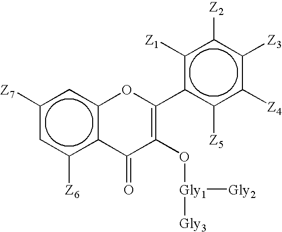
The flavone glycosides according to the invention are particularly advantageously from the group given by the following structure: 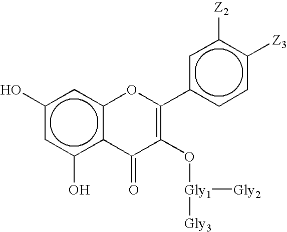
where Gly₁, Gly₂ and Gly₃, independently of one another, are monoglycoside radicals or. Gly₂ and Gly₃ may also, individually or together, represent saturations by hydrogen atoms.

Preferably, Gly₁, Gly₂ and Gly₃ are chosen independently of one another from the group of hexosyl radicals, in particular the rhamnosyl radicals and glucosyl radicals. However, other hexosyl radicals, for example, allosyl, altrosyl, galactosyl, gulosyl, idosyl, mannosy,l and talosyl, can also advantageously be used in some circumstances. It may also be advantageous according to the invention to use pentosyl radicals.

For the purposes of the present invention, it is particularly advantageous to choose the flavone glycoside(s) from the group consisting of α-glucosylrutin, α-glucosylmyricetin, α-glucosylisoquercitrin, α-glucosylisoquercetin, and α-glucosylquercitrin. According to the invention, particular preference is given to α-glucosylrutin.

Also advantageous according to the invention are naringin (aurantin, naringenin-7-rhamnoglucoside), hesperidin (3′,5,7-trihydroxy-4′-methoxyflavanone-7-rutinoside, hesperidoside, hesperetin-7-O-rutinoside), rutin (3,3′,4′,5,7-pentahydroxyflyvon-3-rutinoside, quercetin-3-rutinoside, sophorin, birutan, rutabion, taurutin, phytomelin, melin), troxerutin (3,5-dihydroxy-3′,4′,7-tris(2-hydroxyethoxy)flavone-3-(6-O-(6-deoxy-α-L-mannopyranosyl)-β-D-glucopyranoside)), monoxerutin (3,3′,4′,5-tetrahydroxy-7-(2-hydroxyethoxy)flavone-3-(6-O-(6-deoxy-α-L-mannopyranosyl)-β-D-glucopyranoside)), dihydrorobinetin (3,3′,4′,5′,7-pentahydroxyflavanone), taxifolin (3,3′,4′,5,7-pentahydroxyflavanone), eriodictyol-7-glucoside (3′,4′,5,7-tetrahydroxyflavanone-7-glucoside), flavanomarein (3′,4′,7,8-tetrahydroxyflavanone-7-glucoside) and isoquercetin (3,3′,4′,5,7-pentahydroxyflavanone-3-(β-D-glucopyranoside).

It is also advantageous to choose the active ingredient(s) from the group of ubiquinones and plastoquinones. Ubiquinones are characterized by the structural formula: 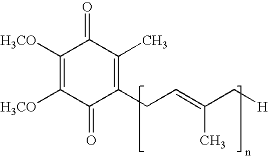
and are the most widespread and thus the most investigated bioquinones. Ubiquinones are referred to, depending on the number of isoprene units linked in the side chain, as Q-1, Q-2, Q-3, etc., or, according to the number of carbon atoms, as U-5, U-10, U-15, etc. They preferably arise with certain chain lengths, e.g., in some microorganisms and yeasts where n=6. In most mammals including man, Q10 predominates.

Coenzyme Q10 is particularly advantageous and is characterized by the following structural formula: 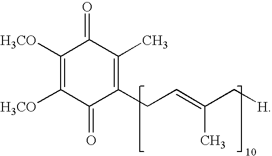
Plastoquinones have the general structural formula: 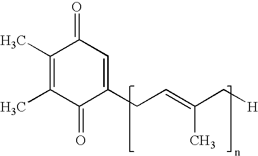
Plastoquinones differ in the number n of isoprene radicals and are referred to accordingly, e.g., PQ-9 (n=9). In addition, other plastoquinones with varying substituents on the quinone ring exist.

Creatine and/or creatinee derivatives, phosphocreatinee are also preferred active ingredients for the purposes of the present invention. Creatine is characterized by the following structure:

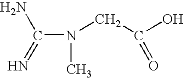

Preferred derivatives are creatinee phosphate, creatinee sulfate, creatinee acetate, creatinee ascorbate, and the derivatives esterified on the carboxyl group with mono- or polyfunctional alcohols.

A further advantageous active ingredient is L-carnitine [3-hydroxy-4-(trimethylammonio)butyrobetaine]. Acylcarnitines, chosen from the group of substances of the following general structural formula: 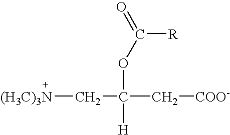
where R is chosen from the group of branched and unbranched alkyl radicals having up to 10 carbon atoms, are also advantageous active ingredients for the purposes of the present invention. Preference is given to propionylcarnitine and, in particular, acetylcarnitine. Both enantiomers (D and L form) are to be used advantageously for the purposes of the present invention. It may also be advantageous to use any enantiomer mixtures, for example a racemate of D and L form.

Further advantageous active ingredients are sericoside, pyridoxol, aminoguadine, phytochelatin, isoflavones (genistein, daidzein, daidzin, glycitin), niacin, tyrosine sulfate, dioic acid, adenosine, pyridoxine, arginine, vitamin K, biotin and aroma substances.

The list of said active ingredients and active ingredient combinations which can be used in the preparations according to the invention is not of course intended to be limiting. The active ingredients can be used individually or in any combinations with one another.

Active ingredients may be present in the preparations in the amounts of 0.0001 to 25% by weight, preferably 0.001 to 20% by weight, in particular 0.01 to 10% by weight, in each case based on the total weight of the preparations.

Although the use of hydrophilic active ingredients is of course also favored according to the invention, a further advantage of the preparations according to the invention is that the high number of very finely divided droplets makes oil-soluble and/or lipophilic active ingredients in particular bioavailable with particularly good effectiveness.

It is also advantageous to choose the active ingredients from the group of refatting substances, for example purcellin oil, Eucerit®, and Neocerit®.

It is also possible and in some instances advantageous to add washing-active surfactants to the preparations according to the invention. Aqueous cosmetic cleansing agents according to the invention or low-water or anhydrous cleansing agent concentrates intended for aqueous cleansing can comprise cationic, anionic, nonionic and/or amphoteric surfactants, for example, conventional soaps, e.g., fatty acid salts of sodium, alkyl sulfates, alkyl ether sulfates, alkane- and alkylbenzenesulfonates, sulfoacetates, sulfobetaines, sarcosinates, amidosulfobetaines, sulfosuccinates, sulfosuccinic monoesters, alkyl ether carboxylates, protein-fatty acid condensates, alkylbetaines and amidobetaines, fatty acid alkanolamides, and polyglycol ether derivatives.

Cosmetic preparations which are cosmetic cleansing preparations for the skin may be present in liquid or semisolid form, for example in the form of gels. They preferably comprise at least one anionic, cationic, nonionic or amphoteric surface-active substance or mixtures thereof, optionally electrolytes and auxiliaries, as are customarily used for this purpose. The surface-active substance can preferably be present in a concentration between 1 and 30% by weight in the cleansing preparations, based on the total weight of the preparations.

Cosmetic preparations which are shampoos preferably comprise at least one anionic, nonionic or amphoteric surface-active substance or mixtures thereof, optionally electrolytes and auxiliaries as are customarily used for this purpose. The surface-active substance can preferably be present in a concentration between 1 and 50% by weight in the cleansing preparations, based on the total weight of the preparations. Cetyltrimethylammonium salts, for example, are to be used advantageously.

The preparations according to the invention intended for the cleansing of hair or skin comprise, apart from the abovementioned surfactants, water and optionally the additives customary in cosmetics, for example, perfume, thickeners, dyes, deodorants, antimicrobial substances, refatting agents, complexing agents and sequestrants, pearlescence agents, plant extracts, vitamins, active ingredients, and the like.

Despite their oil content, the preparations according to the invention surprisingly have very good foam development, high cleansing power and have a high regenerating effect with regard to the general condition of the skin. In particular, the preparations according to the invention have a skin-smoothing effect, reduce the feeling of dryness of the skin and make the skin supple.

If the preparations according to the invention are to be used for hair care, they can comprise the customary constituents, usually, for example, film-forming polymers. Of such polymers with at least partially quaternized nitrogen groups (called below “film formers”), those which are chosen from the group of substances which carry the name “Polyquaternium” according to INCI nomenclature (International Nomenclature Cosmetic Ingredient) are preferably suitable, for example:
Polyquaternium-2 (Chemical Abstracts No. 63451-27-4, e.g. Mirapol® A-15);
Polyquaternium-5 (copolymer of acrylamide and β-methacryloxyethyltrimethyl-ammonium methosulfate, CAS No. 26006-22-4);
Polyquaternium-6 (homopolymer of N,N-dimethyl-N-2-propenyl-2-propen-1-aminium chloride, CAS No. 26062-79-3, e.g. Merquat® 100);
Polyquaternium-7 N,N-dimethyl-N-2-propenyl-2-propen-1-aminium chloride, polymer with 2-propenamide, CAS No. 26590-05-6, e.g. Merquat® S;
Polyquaternium-10 quaternary ammonium salt of hydroxyethylcellulose, CAS No. 53568-66-4, 55353-19-0, 54351-50-7, 68610-92-4, 81859-24-7, e.g. Celquat® SC-230M; Polyquaternium-11 vinylpyrrolidone/dimethylaminoethyl methacrylate copolymer/diethyl sulfate reaction product, CAS No. 53633-54-8, e.g. Gafquat® 755N;
Polyquaternium-16 vinylpyrrolidone/vinylimidazolinium methochloride copolymer, CAS No. 29297-55-0, e.g. Luviquat® HM 552;
Polyquaternium-17 CAS No. 90624-75-2, e.g. Mirapol® AD-1
Polyquaternium-19 quaternized water-soluble polyvinyl alcohol;
Polyquaternium-20 water-dispersible quaternized polyvinyl octadecyl ether;
Polyquaternium-21 polysiloxane-polydimethyl-dimethylammonium acetate copolymer, e.g. Abil® B 9905;
Polyquaternium-22 dimethyldiallylammonium chloride/acrylic acid copolymer, CAS No. 53694-7-0, e.g. Merquat® 280;
Polyquaternium-24 polymeric quaternary ammonium salt of hydroxyethylcellulose, reaction product with an epoxide substituted by lauryldimethylammonium, CAS No. 107987-23-5, e.g. Quatrisoft® LM-200;
Polyquaternium-28 vinylpyrrolidone/methacrylamidopropyltrimethylammonium chloride copolymer, e.g. Gafquat® HS-100;
Polyquaternium-29 e.g. Lexquat® CH;
Polyquaternium-31 CAS No. 136505-O₂-7, e.g. Hypan® QT 100;
Polyquaternium-32 N,N, N-trimethyl-2-[(2-methyl-1-oxo-2-propenyl)oxy]ethanaminium chloride, polymer with 2-propenamide, CAS No. 35429-19-7;
Polyquaternium-37 CAS No. 26161-33-1; and
Cetyltrimethylammonium salts such as CTAB and CTAC.

Hair care preparations according to the invention advantageously comprise 0.01 to 5% by weight of one or more film formers, preferably 0.1 to 3% by weight, in particular 0.2 to 2% by weight, in each case based on the total weight of the preparations. Such embodiments of the preparations according to the invention care for hair which has been stripped or damaged by environmental influences, or protect against such influences. In addition, the preparations according to the invention give the hairstyle relaxed fullness and strength without having a sticky effect.

Correspondingly, depending on their formulation, the preparations according to the invention can, for example, be used as skin protection emulsion, cleansing milk, sunscreen lotion, nutrient lotion, day or night emulsion etc.

The preparations according to the invention further advantageously contribute to skin smoothing, particularly when they are provided with one or more substances which promote skin smoothing.

It is in some cases possible and advantageous to use the preparations according to the invention as bases for pharmaceutical formulations. Corresponding requirements apply mutatis mutandis to the formulation of medicinal preparations. The boundaries between pure cosmetics and pure pharmaceuticals are fluid here. According to the invention, suitable pharmaceutical active ingredients are fundamentally all classes of active ingredient, preference being given to lipophilic active ingredients. Examples are: antihistamines, antiphlogistics, antibiotics, antimycotics, active ingredients which promote circulation, keratolytics, hormones, steroids, vitamins, etc.

The cosmetic and dermatological preparations according to the invention can comprise cosmetic auxiliaries as are customarily used in such preparations, e.g., preservatives, bactericides, virucides, perfumes, substances for preventing foaming, dyes, pigments which have a coloring effect, thickeners, surface-active substances, emulsifiers, softening, moisturizing and humectant substances, anti-inflammatory substances, medicaments, fats, oils, waxes, or other customary constituents of a cosmetic or dermatological formulation, such as alcohols, polyols, polymers, foam stabilizers, electrolytes, organic solvents.

Mixtures of the abovementioned solvents are used particularly advantageously.

Further constituents which may be used are fats, waxes and other natural and synthetic fatty bodies, preferably esters of fatty acids with alcohols of low carbon number, e.g., with isopropanol, propylene glycol or glycerol, or esters of fatty alcohols with alkanoic acids of low carbon number or with fatty acids, alcohols, diols, or polyols of low carbon number, and ethers thereof, preferably ethanol, isopropanol, propylene glycol, glycerol, ethylene glycol, ethylene glycol monoethyl or monobutyl ether, propylene glycol monomethyl, monoethyl or monobutyl ether, diethylene glycol monomethyl or monoethyl ether, and analogous products.

Unless stated otherwise, all amounts, percentages or parts refer to the weight of the preparations or of the particular mixture.

### EXAMPLES

The examples below are intended to illustrate the present invention. The lecithin used in the examples was phosphatidylcholine (Phospholipon 90, Rhone-Poulenc/Nattermann).

### Example 1

Face care product

| | % by wt. |
|---|---|
| Lecithin | 1.800 |
| PEG-50 hydrogenated castor oil isostearate | 5.200 |
| Glycerol | 5.000 |
| Dicaprylyl ether | 7.000 |
| Preservative | q.s. |
| Water | ad |
| | 100.000 |

### Example 2

Antiacne lotion

| | % by wt. |
|---|---|
| Lecithin | 3.000 |
| PEG-20 sorbitan isostearate | 4.000 |
| Glycerol | 5.000 |
| Dicaprylyl ether | 7.000 |
| Preservative | q.s. |
| Water | ad |
| | 100.000 |

### Example 3

Hair tonic

| | % by wt. |
|---|---|
| Lecithin | 3.000 |
| Oleth-15 | 4.000 |
| Glycerol | 5.000 |
| Dicaprylyl ether | 7.000 |
| Preservative | q.s. |
| Water | ad |
| | 100.000 |

### Example 4

Body lotion

| | % by wt. |
|---|---|
| Lecithin | 3.000 |
| PEG-45 palm kernel oil glycerides | 4.000 |
| Glycerol | 5.000 |
| Dicaprylyl ether | 7.000 |
| Preservative | q.s. |
| Water | ad |
| | 100.000 |

### Example 5

Base for shaving foam

| | % by wt. |
|---|---|
| Lecithin | 3.000 |
| PEG-20 sorbitan monooleate | 4.000 |
| Glycerol | 5.000 |
| Dicaprylyl ether | 7.000 |
| Preservative | q.s. |
| Water | ad |
| | 100.000 |

### Example 6

Aftershave lotion

| | % by wt. |
|---|---|
| Lecithin | 1.000 |
| Polyglyceryl-10 stearate | 6.000 |
| Glycerol | 5.000 |
| Dicaprylyl ether | 7.000 |
| Preservative | q.s. |
| Water | ad |
| | 100.000 |

### Example 7

Face cleansing wash

| | % by wt. |
|---|---|
| Lecithin | 2.000 |
| Decaglyceryl monolaurate | 5.000 |
| Glycerol | 5.000 |
| Dicaprylyl ether | 7.000 |
| Preservative | q.s. |
| Water | ad |
| | 100.000 |

### Example 8

Shower oil, low-foaming

| | % by wt. |
|---|---|
| Lecithin | 3.500 |
| PEG-20 glyceryl laurate | 3.500 |
| Glycerol | 5.000 |
| Dicaprylyl ether | 7.000 |
| Preservative | q.s |
| Water | ad |
| | 100.000 |

### Example 9

Pump atomizer for deodorant/antiperspirant products

| | % by wt. |
|---|---|
| Lecithin | 3.000 |
| PEG-20 monostearate | 4.000 |
| Glycerol | 5.000 |
| Dicaprylyl ether | 7.000 |
| Preservative | q.s. |
| Water | ad |
| | 100.000 |

### Example 10

Cleansing emulsion to combat greasy skin

| | % by wt. |
|---|---|
| Lecithin | 3.000 |
| PEG-20 glyceryl stearate | 4.000 |
| Glycerol | 5.000 |
| Dicaprylyl ether | 7.000 |
| Preservative | q.s. |
| Water | ad |
| | 100.000 |

### Example 11

Refreshing preshave lotion

| | % by wt. |
|---|---|
| Lecithin | 4.000 |
| Ceteareth-12 | 3.000 |
| Glycerol | 5.000 |
| Dicaprylyl ether | 7.000 |
| Preservative | q.s. |
| Water | ad |
| | 100.000 |

### Example 12

Make-up remover lotion

| | % by wt. |
|---|---|
| Lecithin | 2.000 |
| PEG-20 sorbitan isostearate | 5.000 |
| Glycerol | 5.000 |
| Octyl dodecanol | 7.000 |
| Preservative | q.s. |
| Water | ad |
| | 100.000 |

### Example 13

Base for solubilizing perfume odorants (perfume atomizer)

| | % by wt. |
|---|---|
| Lecithin | 2.000 |
| PEG-20 sorbitan isostearate | 5.000 |
| Glycerol | 5.000 |
| Cetearyl isononanoate | 7.000 |
| Preservative | q.s. |
| Water | ad |
| | 100.000 |

### Example 14

Base for scalp treatment

| | % by wt. |
|---|---|
| Lecithin | 2.000 |
| PEG-20 sorbitan isostearate | 5.000 |
| Glycerol | 5.000 |
| Dioctyl cyclohexane | 7.000 |
| Preservative | q.s. |
| Water | ad |
| | 100.000 |

### Example 15

Base for a sunscreen spray

| | % by wt. |
|---|---|
| Lecithin | 1.000 |
| Polyglyceryl-10 stearate | 6.000 |
| Glycerol | 5.000 |
| Dioctylcyclohexane | 7.000 |
| Preservative | q.s. |
| Water | ad |
| | 100.000 |

### Example 16

Base for a body spray

| | % by wt. |
|---|---|
| Lecithin | 1.000 |
| Oleth-15 | 6.000 |
| Glycerol | 5.000 |
| Octyldodecanol | 7.000 |
| Preservative | q.s. |
| Water | ad |
| | 100.000 |

### Example 17

| | % by wt. |
|---|---|
| Lecithin | 2.000 |
| Oleth-15 | 5.000 |
| Glycerol | 5.000 |
| Caprylic/capric triglycerides | 7.000 |
| Preservative | q.s. |
| Water | ad |
| | 100.000 |

### Example 18

Wipe impregnation medium

| | % by wt. |
|---|---|
| Lecithin | 3.000 |
| PEG-45 palm kernel oil glycerides | 4.000 |
| Glycerol | 5.000 |
| Dioctylcyclohexane | 7.000 |
| Preservative | q.s. |
| Water | ad |
| | 100.000 |

### Example 19

| | % by wt. |
|---|---|
| Lecithin | 3.000 |
| PEG-45 palm kernel oil glycerides | 4.000 |
| Glycerol | 5.000 |
| Cetearyl isononanoate | 7.000 |
| Preservative | q.s. |
| Water | ad |
| | 100.000 |

### Example 20

| | % by wt. |
|---|---|
| Lecithin | 2.000 |
| PEG-20 sorbitan monooleate | 5.000 |
| Glycerol | 5.000 |
| Octyldodecanol | 7.000 |
| Preservative | q.s. |
| Water | ad |
| | 100.000 |

### Example 21

| | % by wt. |
|---|---|
| Lecithin | 2.000 |
| PEG-20 sorbitan monooleate | 5.000 |
| Glycerol | 5.000 |
| Caprylic/capric triglycerides | 7.000 |
| Preservative | q.s. |
| Water | ad |
| | 100.000 |

### Example 22

| | % by wt. |
|---|---|
| Lecithin | 2.000 |
| PEG-20 sorbitan monooleate | 5.000 |
| Glycerol | 5.000 |
| Cetearyl isononanoate | 7.000 |
| Preservative | q.s. |
| Water | ad |
| | 100.000 |

### Example 23

Shower emulsion

| | % by wt. |
|---|---|
| Lecithin | 0.500 |
| Lauryl ether sulfate (25%) | 40.000 |
| Glycerol | 5.000 |
| Dicaprylyl ether | 7.000 |
| Sodium chloride | 7.000 |
| Water | ad |
| | 100.000 |

### Example 24

Shower base

| | % by wt. |
|---|---|
| Lecithin | 0.870 |
| Lauryl ether sulfate (25%) | 69.600 |
| Glycerol | 8.600 |
| Dicaprylyl ether | 8.700 |
| Sodium chloride | 12.230 |

1. A process for preparing a low-viscosity, atomizable oil-in-water emulsion, comprising a water phase and an oil phase, said process comprising:
mixing a first portion of the water phase and the oil phase to form a gel state, said oil phase including a phospholipid and an oil-in-water emulsifier; and
adding a second portion of the water phase to the gel state to convert the gel state to a low-viscosity oil-in-water emulsion;
wherein the oil phase consists essentially of low volatility constituents.

2. The process as claimed in claim 1, wherein the phospholipid includes a phospholipid selected from the group consisting of phosphatidylserine, phosphatidylcholine, hydrogenated phosphatidylcholine, phosphatidylethanol amine, phosphatidylinositol, and combinations thereof.

3. The process as claimed in claim 1, wherein the oil-in-water emulsifier includes an emulsifier selected from the group consisting of polyethoxylated oil-in-water emulsifiers, polypropoxylated oil-in-water emulsifiers, and combinations thereof.

4. The process as claimed in claim 1, wherein the oil-in-water emulsifier includes an emulsifier selected from the group consisting of ceteth-15, ceteth-16, ceteareth-15, ceteareth-16, isoceteth-20, isosteareth-20, steareth-20, oleth-15, laureth-15, PEG-20 stearate, PEG-25 stearate, PEG-20 oleate, PEG-20 sorbitan stearate, PEG-20 sorbitan isostearate, PEG-20 sorbitan oleate, sodium laureth-11 carboxylate, sodium lauryl ether sulfate, PEG-30 cholesteryl ether, PEG-60 evening primrose glyceride, bis PEG/PPG-16/16 PEG/PPG16/16 dimethicone+caprylic/capric triglyceride, PEG-45 palm kernel oil glyceride, PEG-20 glyceryl laurate, PEG-20 glyceryl stearate, PEG-20 glycerol isostearate PEG/PPG-16/16 PEG/PPG 16/16 dimethicone+caprylic/capric triglyceride, and combinations thereof.

5. The process as claimed in claim 1, further comprising the step of adding at least one water-in-oil emulsifier.

6. The process as claimed in claim 5, wherein the water-in-oil emulsifier comprises an emulsifier selected from the group consisting of glyceryl stearate, glycerol isostearate, glyceryl linoleate, diglycerol isostearate, triglycerol diisostearate, sorbitan isostearate, propylene glycol isostearate, propylene glycol stearate, cetyl alcohol, stearyl alcohol, steareth-2, glyceryl laurate, glyceryl caprinate, glyceryl caprylate, selachyl alcohol, chimyl alcohol, PEG-5 cholesteryl ether PEG-30 dipolyhydroxystearate, polyglyceryl-3 methylglucose distearate, PEG-45/dodecyl glycol copolymer, methoxy-PEG-22-dodecyl glycol copolymer, methylglucose sesquistearate, polyglyceryl-2 dipolyhydroxystearate, cetyl dimethicone copolyols, alkyl methicone copolyols, and alkyl dimethicone ethoxy glucosides.

7. The process as claimed in claim 5, wherein the ratio of phospholipid and oil in water emulsifier to water-in-oil emulsifier is from about 1:30 to 2:1.

8. The process as claimed in claim 5, wherein the oil-in-water emulsifier comprises an emulsifier selected from the group consisting of polyethoxylated oil-in-water emulsifiers, polypropoxylated oil-in-water emulsifiers, and combinations thereof.

9. The process as claimed in claim 1, wherein the oil-in-water emulsifier includes at least one non-ethoxylated oil-in-water emulsifier.

10. The process as claimed in claim 9, wherein the oil-in-water emulsifier comprises a non-ethoxylated oil-in-water emulsifier selected from the group consisting of polyglyceryl-3 methylglucose distearate, glyceryl stearate citrate, polyglycerol-10 stearate, polyglycerol-10 laurate, and combinations thereof.

11. The process as claimed in claim 9, further comprising the step of adding at least one water-in-oil emulsifier.

12. The process as claimed in claim 1, further comprising one or more skin moisturizing agents selected from the group consisting of glycerol, chitosan, Fucogel, 2-methylpropanediol, polyethylene glycol, lactic acid, propylene glycol, dipropylene glycol, butylene glycol, mannitol, acids, sodium pyrolidonecarboxylic acid, hyaluronic acid, amino acids and salts thereof, urea, electrolytes, salts of inorganic acids, and salts of organic acids.

13. The process as claimed in claim 1, wherein the ratio of phospholipid to oil-in-water emulsifier is from about 1:6 to 1:1.3.

14. An atomizable, water-in-oil emulsion comprising:
a) a water phase;
b) oil phase;
c) at least one phospholipid present in an amount from about 0.01 to 10 percent by weight based on the total weight of the emulsion; and
d) at least one oil in water emulsifier present in an amount from about 0.01 to 60 percent by weight based on the total weight of the emulsion,
wherein the ratio of said at least one phospholipid to said at least one oil in water emulsifier is from about 1:15 to 1:1.3.

15. The atomizable, water-in-oil emulsion as claimed in claim 15, further comprising:
e) at least one water-in-oil emulsifier present in an amount from about 0.01 to 60 percent by weight based on the total weight of the emulsion,
wherein the ratio of at least one phospholipid and at least one oil-in-water emulsifier to said water-in-oil emulsifier is from about 1:30 to 2:1.

16. The atomizable, water-in-oil emulsion as claimed in claim 15, wherein the at least one water-in-oil emulsifier includes at least one emulsifier selected from the group consisting of glyceryl stearate, glycerol isostearate, glyceryl linoleate, diglycerol isostearate, triglycerol diisostearate, sorbitan isostearate, propylene glycol isostearate, propylene glycol stearate, cetyl alcohol, stearyl alcohol, steareth-2, glyceryl laurate, glyceryl caprinate, glyceryl caprylate, selachyl alcohol, chimyl alcohol, PEG-5 cholesteryl ether PEG-30 dipolyhydroxystearate, polyglyceryl-3 methylglucose distearate, PEG-45/dodecyl glycol copolymer, methoxy-PEG-22-dodecyl glycol copolymer, methylglucose sesquistearate, polyglyceryl-2 dipolyhydroxystearate, cetyl dimethicone copolyols, alkyl methicone copolyols, and alkyl dimethicone ethoxy glucosides.

17. The atomizable, water-in-oil emulsion as claimed in claim 14, wherein the at least one phospholipid includes at least one phospholipids selected from the group consisting of phosphatidylserine, phosphatidylcholine, hydrogenated phosphatidylcholine, phosphatidylethanol amine, and phosphatidylinositol, and combinations thereof.

18. The atomizable, water-in-oil emulsion as claimed in claim 14, wherein the at least one oil-in-water emulsifier includes at least one emulsifier selected from the group consisting of polyethoxylated oil-in-water emulsifiers, polypropoxylated oil-in-water emulsifiers, and combinations thereof.

19. The atomizable, water-in-oil emulsion as claimed in claim 14, wherein the ratio of said at least one phospholipid to said at least one oil-in-water emulsifier is from about 1:6 to 1:1.3.

20. The atomizable, water-in-oil emulsion as claimed in claim 14, wherein said at least one oil-in-water emulsifier includes at least one non-ethoxylated oil-in-water emulsifier selected from the group consisting of polyglyceryl-3 methylglucose distearate, glyceryl stearate citrate, polyglycerol-10 stearate, polyglycerol-10 laurate, and combinations thereof.
